(19) United States
(12) Patent Application Publication
(10) Pub. No.: US 2026/0187542 A1
(43) Pub. Date: Jul. 2, 2026

(54) PRIVACY-PRESERVING TRAINING OF MACHINE LEARNING MODELS

(71) Applicant: Bytedance Technology Ltd., Grand Cayman (KY)

(72) Inventors: Jian DU, Culver City, CA (US); Yingtai XIAO, Culver City, CA (US)

(21) Appl. No.: 19/548,830

(22) Filed: Feb. 24, 2026

Related U.S. Application Data
(60) Provisional application No. 63/951,248, filed on Dec. 30, 2025.

(51) Int. Cl. G06N 20/00

(52) U.S. Cl. CPC G06N 20/00

(57) ABSTRACT

Methods and systems, including computer programs encoded on computer storage media, are provided. One example method includes: obtaining, using a first type of memory, multiple pairs of sub-tensors based on a first tensor and a second tensor obtained by inputting a sample into an initial model; partitioning the sample along a sequence length of the sample into a plurality of segments, where each segment of the plurality of segments is assigned to a computing unit of a group of computing units of a processor; loading one or more pairs of sub-tensors of the multiple pairs of sub-tensors corresponding to a segment of the plurality of segments to a second type of memory of a corresponding computing unit; and at each computing unit, determining a partial gradient based on the one or more pairs of sub-tensors corresponding to the segment to determine the weight gradient of the sample.

### CROSS-REFERENCE TO RELATED APPLICATIONS

This application claims priority to U.S. Patent Application No. 63/951,248, filed on Dec. 30, 2025. The disclosure of the prior application is considered part of the disclosure of this application and is incorporated in its entirety into this application.

### TECHNICAL FIELD

This disclosure relates to machine learning, and in particular, to training machine learning models based on differential privacy.

### BACKGROUND

Machine learning models (e.g., deep neural networks such as large language models or diffusion transformers) are widely used for text processing or visual generation. To address privacy and licensing concerns associated with training machine learning models on sensitive user data, differential privacy (DP) has emerged as a privacy framework that quantifies and limits the impact of individual data samples on model outputs, ensuring robust protection against privacy leakage. As the sequence length of the input data increases, training processes of machine learning models face severe memory consumption challenges.

### SUMMARY

This specification describes technologies for training machine learning models based on differential privacy. According to a first aspect, a computer-implemented method for training a machine learning model based on differential privacy is provided. The method includes obtaining, using a first type of memory, an initial model with a weight tensor and a set of samples for training the initial model, and obtaining a first tensor and a second tensor by inputting a sample from the set of samples into the initial model. The method includes performing partitioning on the first tensor and the second tensor, including performing partitioning on the first tensor to obtain a plurality of first sub-tensors and performing partitioning on the second tensor to obtain a plurality of second sub-tensors. The method includes loading the plurality of first sub-tensors and the plurality of second sub-tensors to a second type of memory, where the first type of memory has a larger storage capacity than the second type of memory. The method further includes: determining, using the second type of memory, a weight gradient of the sample based on the plurality of first sub-tensors and the plurality of second sub-tensors; determining, using the second type of memory, a weight gradient norm of the sample based on the weight gradient of the sample; determining a clipped gradient based on the weight gradient norm of the sample, the plurality of first sub-tensors, and the plurality of second sub-tensors; determining a global clipped gradient based on clipped gradients of all samples in the set of samples; and determining an updated weight tensor based on the global clipped gradient to obtain an updated model.

With reference to the first aspect, in some implementations, determining, using the second type of memory, the weight gradient of the sample based on the plurality of first sub-tensors and the plurality of second sub-tensors includes: computing a product of one of the plurality of first sub-tensors and one of the plurality of second sub-tensors; and updating a gradient accumulator based on the product. In some implementations, the product is discarded without being written to the first type of memory.

With reference to the first aspect, in some implementations, each of the set of samples has a sequence length with a maximum of T, where T is a positive integer. In some implementations, performing partitioning on the first tensor to obtain the plurality of first sub-tensors includes: performing partitioning on the first tensor along a first dimension of the first tensor corresponding to the sequence length. In some implementations, performing partitioning on the second tensor to obtain the plurality of second sub-tensors includes: performing partitioning on the second tensor along a first dimension of the second tensor corresponding to the sequence length.

With reference to the first aspect, in some implementations, the plurality of first sub-tensors and the plurality of second sub-tensors have a same size in a dimension corresponding to the sequence length.

With reference to the first aspect, in some implementations, performing partitioning on the first tensor and the second tensor includes: splitting the sequence length into N tiles, where N is a positive integer and each of the N tiles has a length TO; and performing partitioning on the first tensor and the second tensor based on at least the length TO. In some implementations, a size of each of the plurality of first sub-tensors in the dimension corresponding to the sequence length is equal to the length TO, and a size of each of the plurality of second sub-tensors in the dimension corresponding to the sequence length is equal to the length TO.

With reference to the first aspect, in some implementations, the first tensor includes a dimension of the sequence length and a first feature dimension, and the second tensor includes the dimension of the sequence length and a second feature dimension. In some implementations, the length TO is determined based on the first feature dimension, the second feature dimension, and a maximum storage capacity of the second type of memory.

With reference to the first aspect, in some implementations, performing partitioning on the first tensor to obtain the plurality of first sub-tensors further includes: performing partitioning on the first tensor along a second dimension of the first tensor corresponding to the first feature dimension. In some implementations, performing partitioning on the second tensor to obtain the plurality of second sub-tensors further includes performing partitioning on the second tensor along a second dimension of the second tensor corresponding to the second feature dimension.

With reference to the first aspect, in some implementations, determining the weight gradient of the sample based on the plurality of first sub-tensors and the plurality of second sub-tensors includes: determining pairs of sub-tensors, where each pair of sub-tensors includes a first sub-tensor from the plurality of first sub-tensors and a second sub-tensor from the plurality of second sub-tensors; for the each pair of sub-tensors, determining a component gradient by performing a tensor multiplication based on the first sub-tensor and the second sub-tensor; and accumulating component gradients corresponding to the pairs of sub-tensors to obtain the weight gradient of the sample.

With reference to the first aspect, in some implementations, obtaining the first tensor and the second tensor includes: obtaining the first tensor by inputting the sample into the initial model and performing forward propagation; determining a loss based on an output of the initial model and a label corresponding to the sample; and obtaining the second tensor by performing back propagation on the loss.

With reference to the first aspect, in some implementations, determining, using the second type of memory, the weight gradient norm of the sample based on the weight gradient of the sample includes: performing a non-linear reduction on the weight gradient of the sample to obtain the weight gradient norm of the sample; and updating a norm accumulator based on the weight gradient norm of the sample. In some implementations, the weight gradient norm of the sample is a scalar.

With reference to the first aspect, in some implementations, determining the updated weight tensor based on the global clipped gradient includes: loading the weight tensor of the initial model to the second type of memory; updating the weight tensor of the initial model using the global clipped gradient to obtain the updated weight tensor; and writing the updated weight tensor to the first type of memory to obtain the updated model.

With reference to the first aspect, in some implementations, the method further includes: adding noise to the global clipped gradient. In some implementations, the updated weight tensor is determined based on the global clipped gradient with the noise.

With reference to the first aspect, in some implementations, the first type of memory is a high bandwidth memory (HBM), and the second type of memory is an on-chip memory.

According to a second aspect, a computer-implemented method for training a machine learning model based on differential privacy is provided. The method includes: obtaining, using a first type of memory, an initial model with a weight tensor and a set of samples for training the initial model; obtaining a first tensor and a second tensor by inputting a sample from the set of samples into the initial model; and obtaining multiple pairs of sub-tensors. In some implementations, each pair of sub-tensors includes a first sub-tensor from the first tensor and a second sub-tensor from the second tensor. The method includes determining, using a second type of memory, a weight gradient of the sample based on the multiple pairs of sub-tensors, including: loading a first pair of the multiple pairs of sub-tensors to a first memory of the second type of memory; and in response to loading the first pair to the first memory, loading the first pair to a second memory of the second type of memory to obtain a first component gradient by performing a computation on the first pair, and loading a second pair of the multiple pairs of sub-tensors to the first memory without waiting for completion of the computation on the first pair. The method further includes: determining, using the second type of memory, a weight gradient norm of the sample based on the weight gradient of the sample; determining a clipped gradient based on the weight gradient norm of the sample, the first tensor, and the second tensor; determining a global clipped gradient based on clipped gradients of all samples in the set of samples; and determining an updated weight tensor based on the global clipped gradient to obtain an updated model.

With reference to the second aspect, in some implementations, the first pair and the second pair are asynchronously loaded to the first memory by a tensor memory accelerator (TMA) engine. In some implementations, performing the computation on the first pair includes: reading the first pair from the second memory to a tensor core; and performing a multiply-accumulation operation on the first pair to obtain the first component gradient.

With reference to the second aspect, in some implementations, the first type of memory has a larger storage capacity than the second type of memory. In some implementations, the first type of memory is a high bandwidth memory (HBM), and the second type of memory is an on-chip memory.

With reference to the second aspect, in some implementations, the first memory is a shared memory, and the second memory is a register.

With reference to the second aspect, in some implementations, determining, using the second type of memory, the weight gradient of the sample based on the multiple pairs of sub-tensors further includes: in response to loading the second pair to the first memory, loading the second pair to the second memory to obtain a second component gradient by performing the computation on the second pair, and loading a third pair of the multiple pairs of sub-tensors to the first memory without waiting for completion of the computation on the second pair; and loading the third pair to the second memory to obtain a third component gradient by performing the computation on the third pair.

With reference to the second aspect, in some implementations, determining, using the second type of memory, the weight gradient of the sample based on the multiple pairs of sub-tensors further includes: determining the weight gradient of the sample by accumulating the first component gradient, the second component gradient, and the third component gradient.

With reference to the second aspect, in some implementations, the second pair is loaded to the first memory based on a group of first compute warps, and the first pair is loaded to the second memory based on a group of second compute warps.

With reference to the second aspect, in some implementations, determining, using the second type of memory, a weight gradient of the sample based on the multiple pairs of sub-tensors includes: computing a product of sub-tensors included in one pair of the multiple pairs of sub-tensors; and updating a gradient accumulator based on the product. In some implementations, the product is discarded without being written to the first type of memory.

With reference to the second aspect, in some implementations, obtaining multiple pairs of sub-tensors includes: performing partitioning on the first tensor to obtain a plurality of first sub-tensors; performing partitioning on the second tensor to obtain a plurality of second sub-tensors; and pairing each of the plurality of first sub-tensors with a corresponding one of the plurality of second sub-tensors to obtain the multiple pairs of sub-tensors.

With reference to the second aspect, in some implementations, obtaining the first tensor and the second tensor includes: obtaining the first tensor by inputting the sample into the initial model and performing forward propagation; determining a loss based on an output of the initial model and a label corresponding to the sample; and obtaining the second tensor by performing back propagation on the loss.

With reference to the second aspect, in some implementations, determining, using the second type of memory, the weight gradient norm of the sample based on the weight gradient of the sample includes: performing a non-linear reduction on the weight gradient of the sample to obtain the weight gradient norm of the sample; and updating a norm accumulator based on the weight gradient norm of the sample. In some implementations, the weight gradient norm of the sample is a scalar.

With reference to the second aspect, in some implementations, determining the updated weight tensor based on the global clipped gradient includes: loading the weight tensor of the initial model to the second type of memory; updating the weight tensor of the initial model using the global clipped gradient to obtain the updated weight tensor; and writing the updated weight tensor to the first type of memory to obtain the updated model.

With reference to the second aspect, in some implementations, the method further includes adding noise to the global clipped gradient. In some implementations, the updated weight tensor is determined based on the global clipped gradient with the noise.

According to a third aspect, a computer-implemented method for training a machine learning model based on differential privacy is provided. The method includes: obtaining, using a first type of memory, an initial model with a weight tensor and a set of samples for training the initial model; obtaining a first tensor and a second tensor by inputting a sample from the set of samples into the initial model; obtaining multiple pairs of sub-tensors, where each pair of sub-tensors includes a first sub-tensor from the first tensor and a second sub-tensor from the second tensor; and partitioning the sample along a sequence length of the sample into a plurality of segments. In some implementations, each segment of the plurality of segments is assigned to a computing unit of a group of computing units of a processor. The method includes loading one or more pairs of sub-tensors of the multiple pairs of sub-tensors corresponding to a segment of the plurality of segments to a second type of memory of a corresponding computing unit. In some implementations, the first type of memory has a larger storage capacity than the second type of memory. The method includes: at each computing unit, determining a partial gradient based on the one or more pairs of sub-tensors corresponding to the segment; and determining, using the second type of memory, a weight gradient of the sample based on partial gradients determined at the group of computing units. The method further includes: determining, using the second type of memory, a weight gradient norm of the sample based on the weight gradient of the sample; determining a clipped gradient based on the weight gradient norm of the sample and the multiple pairs of sub-tensors; determining a global clipped gradient based on clipped gradients of all samples in the set of samples; and determining an updated weight tensor based on the global clipped gradient to obtain an updated model.

With reference to the third aspect, in some implementations, the partial gradients are determined at the group of computing units in parallel.

With reference to the third aspect, in some implementations, each segment of the plurality of segments has an identical size.

With reference to the third aspect, in some implementations, obtaining multiple pairs of sub-tensors based on the first tensor and the second tensor includes: performing partitioning on the first tensor to obtain a plurality of first sub-tensors; performing partitioning on the second tensor to obtain a plurality of second sub-tensors; and pairing each of the plurality of first sub-tensors with a corresponding one of the plurality of second sub-tensors to obtain the multiple pairs of sub-tensors.

With reference to the third aspect, in some implementations, the first tensor includes a dimension of the sequence length and a first feature dimension, and the second tensor includes the dimension of the sequence length and a second feature dimension. In some implementations, partitioning the sample along the sequence length of the sample into the plurality of segments includes: determining a spatial grid size based on a size of the set of samples, a size of the first feature dimension, a size of the second feature dimension, a size of a dimension of the first sub-tensor corresponding to the first feature dimension, and a size of a dimension of the second sub-tensor corresponding to the second feature dimension; determining whether the spatial grid size is smaller than a threshold determined based on a number of computing units of the group of computing units; and in response to determining that the spatial grid size is smaller than the threshold, partitioning the sample along the sequence length of the sample into the plurality of segments.

With reference to the third aspect, in some implementations, a number of segments included in the plurality of segments is determined based on the spatial grid size.

With reference to the third aspect, in some implementations, determining the partial gradient based on the one or more pairs of sub-tensors corresponding to the segment includes: for each of the one or more pairs of sub-tensors, determining a partial gradient by performing a tensor multiplication based on a pair of sub-tensors; and accumulating partial gradients corresponding to the one or more pairs of sub-tensors to obtain the partial gradient.

With reference to the third aspect, in some implementations, determining the weight gradient of the sample based on partial gradients determined at the group of computing units includes: aggregating the partial gradients determined at the group of computing units at a computing unit of the group of computing units to obtain the weight gradient of the sample. In some implementations, the partial gradients determined at the group of computing units are transferred to the computing unit directly without passing through the first type of memory.

With reference to the third aspect, in some implementations, obtaining the first tensor and the second tensor includes: obtaining the first tensor by inputting the sample into the initial model and performing forward propagation; determining a loss based on an output of the initial model and a label corresponding to the sample; and obtaining the second tensor by performing back propagation on the loss.

With reference to the third aspect, in some implementations, determining, using the second type of memory, the weight gradient norm of the sample based on the weight gradient of the sample includes: performing a non-linear reduction on the weight gradient of the sample to obtain the weight gradient norm of the sample; and updating a norm accumulator based on the weight gradient norm of the sample. In some implementations, the weight gradient norm of the sample is a scalar.

With reference to the third aspect, in some implementations, determining the updated weight tensor based on the global clipped gradient includes: loading the weight tensor of the initial model to the second type of memory; updating the weight tensor of the initial model using the global clipped gradient to obtain the updated weight tensor; and writing the updated weight tensor to the first type of memory to obtain the updated model.

With reference to the third aspect, in some implementations, the method further includes: adding noise to the global clipped gradient. In some implementations, the updated weight tensor is determined based on the global clipped gradient with the noise.

With reference to the third aspect, in some implementations, the first type of memory is a high bandwidth memory (HBM), and the second type of memory is an on-chip memory.

According to a fourth aspect, a computer-implemented method for training a machine learning model based on differential privacy is provided. The method includes: obtaining, using a first type of memory, an initial model with a weight tensor and a set of samples for training the initial model. In some implementations, each of the set of samples has a sequence length with a maximum of T, where T is a positive integer. The method includes: obtaining a first tensor and a second tensor by inputting a sample from the set of samples into the initial model. In some implementations, the first tensor includes a dimension of the sequence length and a first feature dimension, and the second tensor includes a dimension of the sequence length and a second feature dimension. The method includes: performing partitioning on the first tensor along the first feature dimension to obtain a plurality of first sub-tensors; performing partitioning on the second tensor along the second feature dimension to obtain a plurality of second sub-tensors; and obtaining multiple pairs of sub-tensors based on the plurality of first sub-tensors and the plurality of second sub-tensors. In some implementations, each pair of sub-tensors includes a first sub-tensor of the plurality of first sub-tensors and a corresponding second sub-tensor from the plurality of second sub-tensors. The method includes: determining a spatial grid size based on a size of the set of samples, a size of the first feature dimension, a size of the second feature dimension, a size of a dimension of each first sub-tensor of the plurality of first sub-tensors corresponding to the first feature dimension, and a size of a dimension of each second sub-tensor of the plurality of second sub-tensors corresponding to the second feature dimension; determining whether the spatial grid size meets a threshold; and determining whether to partition the sample along the sequence length of the sample into a plurality of segments based on whether the spatial grid size meets the threshold. In some implementations, each segment of the plurality of segments is assigned to one of a plurality of computing units of a processor for parallel processing.

With reference to the fourth aspect, in some implementations, the plurality of first sub-tensors and the plurality of second sub-tensors have a same size in a dimension corresponding to the sequence length.

With reference to the fourth aspect, in some implementations, the threshold is determined based on a number of computing units in the plurality of computing units.

With reference to the fourth aspect, in some implementations, obtaining the first tensor and the second tensor includes: obtaining the first tensor by inputting the sample into the initial model and performing forward propagation; determining a loss based on an output of the initial model and a label corresponding to the sample; and obtaining the second tensor by performing back propagation on the loss.

With reference to the fourth aspect, in some implementations, determining whether to partition the sample along the sequence length of the sample into the plurality of segments based on whether the spatial grid size meets the threshold includes: in response to determining that the spatial grid size does not meet the threshold, performing a first computation strategy on the plurality of first sub-tensors and the plurality of second sub-tensors to obtain a weight gradient of the sample. In some implementations, the first computation strategy includes: loading the multiple pairs of sub-tensors to more than one second type of memory of the plurality of computing units of the processor; and determining, using the more than one second type of memory, the weight gradient of the sample based on the multiple pairs of sub-tensors. In some implementations, the first type of memory has a larger storage capacity than the second type of memory.

With reference to the fourth aspect, in some implementations, the first computation strategy includes: partitioning a sequence length of the sample into a plurality of segments, where each segment of the plurality of segments is assigned to one of the plurality of computing units of the processor; loading one or more pairs of sub-tensors of the multiple pairs of sub-tensors corresponding to a segment of the plurality of segments to a second type of memory of a corresponding computing unit; at each computing unit, determining a partial gradient based on the one or more pairs of sub-tensors; and determining the weight gradient of the sample based on partial gradients determined at all computing units.

With reference to the fourth aspect, in some implementations, determining whether to partition the sample along the sequence length of the sample into the plurality of segments based on whether the spatial grid size meets the threshold includes: in response to determining that the spatial grid size meets the threshold, performing a second computation strategy on the plurality of first sub-tensors and the plurality of second sub-tensors to obtain a weight gradient of the sample. In some implementations, the second computation strategy includes: loading the multiple pairs of sub-tensors to a second type of memory of a computing unit of the plurality of computing units of the processor; and determining, using the second type of memory, the weight gradient of the sample based on the multiple pairs of sub-tensors. In some implementations, the first type of memory has a larger storage capacity than the second type of memory.

With reference to the fourth aspect, in some implementations, the first type of memory is a high bandwidth memory (HBM), and the second type of memory is an on-chip memory.

With reference to the fourth aspect, in some implementations, determining, using the second type of memory, the weight gradient of the sample based on the multiple pairs of sub-tensors includes: computing a product of one of the plurality of first sub-tensors and one of the plurality of second sub-tensors; and updating a gradient accumulator based on the product. In some implementations, the product is discarded without being written to the first type of memory.

With reference to the fourth aspect, in some implementations, the method further includes: determining, using the second type of memory, a weight gradient norm of the sample based on the weight gradient of the sample; determining a clipped gradient based on the weight gradient norm of the sample, the plurality of first sub-tensors, and the plurality of second sub-tensors; determining a global clipped gradient based on clipped gradients of all samples included in the set of samples; and determining an updated weight tensor based on the global clipped gradient to obtain an updated model.

With reference to the fourth aspect, in some implementations, determining, using the second type of memory, the weight gradient norm of the sample based on the weight gradient of the sample includes: performing a non-linear reduction on the weight gradient of the sample to obtain the weight gradient norm of the sample; and updating a norm accumulator based on the weight gradient norm of the sample. In some implementations, the weight gradient norm of the sample is a scalar.

With reference to the fourth aspect, in some implementations, determining the updated weight tensor based on the global clipped gradient includes: loading the weight tensor of the initial model to the second type of memory; updating the weight tensor of the initial model using the global clipped gradient to obtain the updated weight tensor; and writing the updated weight tensor to the first type of memory to obtain the updated model.

With reference to the fourth aspect, in some implementations, the method further includes: adding noise to the global clipped gradient. In some implementations, the updated weight tensor is determined based on the global clipped gradient with the noise.

According to some other aspects, one or more non-transitory computer-readable storage media are provided. The one or more non-transitory computer-readable storage media store one or more instructions that, when executable by one or more computers, cause the one or more computers to perform the method according to the first, second, third, and/or fourth aspect and/or one or more implementations of the first, second, third, and/or fourth aspect.

According to some other aspects, one or more computer-implemented systems are provided. The one or more computer-implemented systems include one or more computers and one or more computer memory devices interoperably coupled with the one or more computers. The one or more computer memory devices have computer-readable storage media storing one or more instructions that, when executed by the one or more computers, perform the method according to the first, second, third, and/or fourth aspect and/or one or more implementations of the first, second, third, and/or fourth aspect.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example process of determining norms for samples in a model training database via a register-centric strip-mined decomposition approach, according to one or more implementations of the present disclosure.

FIG. 2 illustrates a schematic diagram of an example asynchronous software pipelining process.

FIG. 3 illustrates an example dataflow according to the split-T partitioning mechanism.

FIG. 4 illustrates an example process of determining pre-sample norms for samples in a mini-batch of data for training a machine learning model.

FIG. 5A illustrates an example process of training a machine learning model based on differential privacy.

FIG. 5B illustrates an example process of training a machine learning model based on differential privacy.

FIG. 5C illustrates an example process of training a machine learning model based on differential privacy.

FIG. 5D illustrates an example process of training a machine learning model based on differential privacy.

FIG. 6 is an example computing system for implementing multi-party computations, for example, for sorting data in the form of secret shares.

Like reference numbers and designations in the various drawings indicate like elements.

### DETAILED DESCRIPTION

Machine learning models, for example, deep neural networks (DNNs) such as large language models (LLMs) and diffusion transformers (DiTs), are widely used for text processing or visual generation. In some implementations, to address privacy and licensing concerns associated with training machine learning models on sensitive user data (e.g., personal data or private visual content), differential privacy (DP) has emerged as a privacy framework that quantifies and limits the impact of individual data samples on model outputs, ensuring robust protection against privacy leakage. As an example, to operationalize differential privacy in large-scale model training, differentially private stochastic gradient descent (DP-SGD) has developed as a privacy-preserving training framework for large-scale sensitive data training, which can achieve privacy guarantees by preventing the leakage of sensitive information in the training data during the model training process. DP-SGD combines the differential privacy paradigm with the stochastic gradient descent (SGD) optimization algorithm by introducing gradient clipping and noise addition operations. The gradient clipping refers to an operation that clips individual gradients to a fixed norm, such that the norm of each per-sample gradient can be constrained to a preset threshold to prevent overly large gradients from dominating the training process and leaking sensitive information. The noise addition (also known as gradient perturbation) refers to an operation that adds noise to the aggregated gradients of each mini-batch (i.e., a subset of the training dataset containing a predefined number of samples), so as to mask the contribution of individual training samples.

For example, given that a standard supervised learning setting with model parameters W (also referred to as the weight matrix of the model) is trained on a dataset [symbol] , DP-SGD bounds the influence of individual training samples by clipping the norm (e.g., [symbol] ₂ norm) of per-sample gradients g⁽ⁱ⁾=∇_{W} [symbol] (W, xᵢ) before aggregation, then adding noise (e.g., calibrated Gaussian noise) to the aggregated gradient to achieve differential privacy guarantees. The update rule of DP-SGD can be represented according to the following equation (1):

$$\overline{ℊ} = \frac{1}{B} {\sum }_{i = 1}^{B} ( {ℊ}^{( i )} \cdot min ( 1 , \frac{C}{{‖ {ℊ}^{( i )} ‖}_{2}} ) ) + 𝒩 ( 0 , {σ}^{2} {C}^{2} I ) \qquad ( 1 )$$

where B indicates the mini-batch size, the number of training samples used to compute the aggregated gradient and update model parameters W in a single iteration of the training algorithm; C indicates the gradient clipping threshold, and [symbol] (0, σ²C² [symbol] ) indicates the Gaussian noise tensor scaled to ensure privacy. With reference to equation (1), for a linear layer with input activation tensor A⁽ⁱ⁾∈ [symbol] and output gradient tensor G⁽ⁱ⁾∈ [symbol] , the per-sample gradient can be obtained as g⁽ⁱ⁾=A^{(i)T}G⁽ⁱ⁾.

In some implementations, training models such as LLMs or DiTs require processing input data with long sequence lengths (e.g., denoted as T). For example, LLMs are often configured with expanded context windows ranging from 32,000 to 128,000 tokens to enable document-level reasoning tasks (e.g., analysis of long-form texts, multi-document synthesis, and contextual understanding across extended textual content); and DiTs process sequences of flattened image or video patches, where the sequence length increases substantially as the resolution of the input image or video rises (e.g., high-resolution images or frame sequences of video content result in a dramatic growth in the number of flattened patches), directly expanding the sequence length to be processed. In some implementations, a machine learning model designed to process and learn from long-sequence input data can be referred to as a long-sequence machine learning model. As the sequence length of the input data increases, training processes face severe memory consumption challenges, where memory usage scales quadratically with the sequence length of the input data. This quadratic growth in memory demand frequently results in memory overflow (e.g., out-of-memory (OOM) errors) on computing hardware, for example, graphics processing units (GPUs) with on-chip memory (e.g., static random-access memory (SRAM) and registers (also known as thread-local registers or thread-private registers)) and off-chip memory (e.g., high-bandwidth memory (HBM)). Such memory limitations prevent the effective training of long-sequence machine learning models, thereby restricting the model performance in scenarios where long text sequences, high-resolution images, or other large-scale sequential data are used as input data.

In some implementations, integrating DP-SGD into the training of long-sequence machine learning models aggravates the above-mentioned memory challenges. For example, DP-SGD requires computing the per-sample gradient norm to clip the contribution of each sample before gradient aggregation, where the element-wise per-sample gradients need to be stored in memory for norm calculation. In general, with reference to the above equation (1), the [symbol] ₂ norm of per-sample gradients g⁽ⁱ⁾ (e.g., denoted as ∥g⁽ⁱ⁾∥₂) can be determined based on explicit materialization (e.g., Opacus) or implicit kernel trick (e.g., ghost clipping, backward kernels (BK)). Explicit materialization directly instantiates and stores the full per-sample gradient matrix g⁽ⁱ⁾ to compute the [symbol] ₂ norm, which introduces a memory complexity of O(Bdp) where B is the mini-batch size, d is the dimension of the input activation tensor, and p is the dimension of the output gradient tensor. This O(Bdp) memory overhead often causes OOM errors for large batch sizes or high-dimensional models. The implicit kernel trick computes the squared norm (e.g., denoted as

$${‖ {ℊ}^{( i )} ‖}_{2}^{2} )$$

via a trace-based transformation

$${‖ {ℊ}^{( i )} ‖}_{2}^{2} = tr ( A {A}^{T} G {G}^{T} )$$

to avoid constructing the full d×p gradient matrix. However, the implicit kernel trick introduces a memory complexity of O(T²), where T is the sequence length of the input data, by materializing a T×T Gram matrix, which becomes computationally prohibitive for machine learning models where T>>d (e.g., LLMs with sequence lengths T≥32,000). In some implementations, additional memory is required to store the calibrated noise tensors that are added to the clipped and aggregated gradients to achieve differential privacy guarantees. As a result, DP-SGD-based training of long-sequence machine learning models incurs significantly increased memory costs, giving rise to an urgent unmet need for privacy-preserving training methods that mitigate memory consumption when processing long-sequence input data.

The present disclosure provides techniques for privacy-preserving training of machine learning models. In some implementations, the present disclosure provides a series of memory-optimized operations that reduce memory overhead by avoiding the explicit storage of large gradient matrices, leveraging computing hardware (e.g., GPU) optimizations, and maintaining the differential privacy guarantee.

As an example, the present disclosure provides a computer-implemented method for training a machine learning model based on differential privacy. In some implementations, an initial model with a weight tensor and a set of samples for training the initial model are obtained using a first type of memory (e.g., off-chip memory of a GPU, such as HBM). In some implementations, a first tensor (e.g., input activation matrix of the initial model) and a second tensor (e.g., output gradient matrix of the initial model) are obtained by inputting a sample from the set of samples into the initial model. In some implementations, partitioning is performed on the first tensor and the second tensor. In some implementations, a plurality of first sub-tensors is obtained by performing partitioning on the first tensor, and a plurality of second sub-tensors is obtained by performing partitioning on the second tensor. In some implementations, the plurality of first sub-tensors and the plurality of second sub-tensors are loaded to a second type of memory (e.g., on-chip memory of the GPU). The first type of memory has a larger storage capacity than the second type of memory. In some implementations, using the second type of memory, a weight gradient of the sample is determined based on the plurality of first sub-tensors and the plurality of second sub-tensors, and a weight gradient norm of the sample is then determined based on the weight gradient of the sample. In some implementations, a clipped gradient is determined based on the weight gradient norm of the sample, the plurality of first sub-tensors, and the plurality of second sub-tensors. In some implementations, a global clipped gradient is determined based on clipped gradients of all samples in the set of samples, and an updated weight tensor is determined based on the global clipped gradient to obtain an updated model.

As another example, the present disclosure provides a computer-implemented method for training a machine learning model based on differential privacy. In some implementations, an initial model with a weight tensor and a set of samples for training the initial model are obtained using a first type of memory (e.g., off-chip memory of a GPU, such as HBM). In some implementations, a first tensor (e.g., input activation matrix of the initial model) and a second tensor (e.g., output gradient matrix of the initial model) are obtained by inputting a sample from the set of samples into the initial model. In some implementations, multiple pairs of sub-tensors are obtained, where each pair of sub-tensors includes a first sub-tensor from the first tensor and a second sub-tensor from the second tensor. In some implementations, a weight gradient of the sample is determined based on the multiple pairs of sub-tensors using a second type of memory, where a first pair of the multiple pairs of sub-tensors is loaded to a first memory of the second type of memory, and in response to loading the first pair to the first memory, the first pair is loaded to a second memory of the second type of memory to obtain a first component gradient by performing a computation on the first pair, and a second pair of the multiple pairs of sub-tensors is loaded to the first memory without waiting for completion of the computation on the first pair. In some implementations, a weight gradient norm of the sample is determined based on the weight gradient of the sample. In some implementations, a clipped gradient is determined based on the weight gradient norm of the sample, the plurality of first sub-tensors, and the plurality of second sub-tensors. In some implementations, a global clipped gradient is determined based on clipped gradients of all samples in the set of samples, and an updated weight tensor is determined based on the global clipped gradient to obtain an updated model.

As another example, the present disclosure provides a computer-implemented method for training a machine learning model based on differential privacy. In some implementations, an initial model with a weight tensor and a set of samples for training the initial model are obtained using a first type of memory (e.g., off-chip memory of a GPU, such as HBM). In some implementations, a first tensor (e.g., input activation matrix of the initial model) and a second tensor (e.g., output gradient matrix of the initial model) are obtained by inputting a sample from the set of samples into the initial model. In some implementations, multiple pairs of sub-tensors are obtained, where each pair of sub-tensors includes a first sub-tensor from the first tensor and a second sub-tensor from the second tensor. In some implementations, the sample is partitioned along a sequence length of the sample into a plurality of segments, where each segment of the plurality of segments is assigned to a computing unit of a group of computing units of a processor. In some implementations, one or more pairs of sub-tensors of the multiple pairs of sub-tensors corresponding are loaded to a segment of the plurality of segments to a second type of memory of a corresponding computing unit. In some implementations, the first type of memory has a larger storage capacity than the second type of memory. In some implementations, at each computing unit, a partial gradient is determined based on the one or more pairs of sub-tensors corresponding to the segment. In some implementations, a weight gradient of the sample is determined based on partial gradients determined at the group of computing units using a second type of memory. In some implementations, a weight gradient norm of the sample is determined based on the weight gradient of the sample. In some implementations, a clipped gradient is determined based on the weight gradient norm of the sample, the plurality of first sub-tensors, and the plurality of second sub-tensors. In some implementations, a global clipped gradient is determined based on clipped gradients of all samples in the set of samples, and an updated weight tensor is determined based on the global clipped gradient to obtain an updated model.

As another example, the present disclosure provides a computer-implemented method for training a machine learning model based on differential privacy. In some implementations, an initial model with a weight tensor and a set of samples for training the initial model are obtained using a first type of memory (e.g., off-chip memory of a GPU, such as HBM). In some implementations, each of the set of samples has a sequence length with a maximum of T, where T is a positive integer. In some implementations, a first tensor (e.g., input activation matrix of the initial model) and a second tensor (e.g., output gradient matrix of the initial model) are obtained by inputting a sample from the set of samples into the initial model. In some implementations, the first tensor includes a dimension of the sequence length and a first feature dimension, and the second tensor includes a dimension of the sequence length and a second feature dimension. In some implementations, a plurality of first sub-tensors is obtained by performing partitioning on the first tensor along the first feature dimension, and a plurality of second sub-tensors is obatind by performing partitioning on the second tensor along the second feature dimension. In some implementations, multiple pairs of sub-tensors are obtained based on the plurality of first sub-tensors and the plurality of second sub-tensors. In some implementations, each pair of sub-tensors includes a first sub-tensor of the plurality of first sub-tensors and a corresponding second sub-tensor from the plurality of second sub-tensors. In some implementations, a spatial grid size is determined based on a size of the set of samples, a size of the first feature dimension, a size of the second feature dimension, a size of a dimension of each first sub-tensor of the plurality of first sub-tensors corresponding to the first feature dimension, and a size of a dimension of each second sub-tensor of the plurality of second sub-tensors corresponding to the second feature dimension. In some implementations, a determination is made on whether the spatial grid size meets a threshold. In some implementations, a determination is made on whether to partition the sample along the sequence length of the sample into a plurality of segments based on whether the spatial grid size meets the threshold. In some implementations, each segment of the plurality of segments is assigned to one of a plurality of computing units of a processor for parallel processing.

The described techniques can achieve one or more technical benefits/advantages.

In some implementations, the described techniques enable substantial memory savings by preventing the materialization of weight gradients for individual samples in the global memory (e.g., HBM). For example, the gradient accumulation is performed exclusively within registers to eliminate global memory write traffic. As another example, the weight gradient of the sample and the corresponding gradient norm are determined entirely within the registers, with only the gradient norm being written back to the HBM. In some implementations, the described techniques can achieve O(1) memory complexity with respect to merely sequence length T, which is independent of both batch size B and the magnitude of sequence length T. In some implementations, the described techniques decouple the linear accumulation phase from the non-linear reduction phase for norm computation to ensure computational exactness while maintaining a constant memory footprint.

In some implementations, the described techniques enable efficient re-streaming data for norm computation and gradient update. For example, an asynchronous pipelining can be applied to a first data stream (e.g., loading the first pair to a second memory of the second type of memory to obtain a first component gradient by performing a computation on the first pair) and a second data stream (e.g., loading a second pair of the multiple pairs of sub-tensors to the first memory). In some implementations, the I/O latency associated with the second data stream can be masked by the computational operations of the first data stream through asynchronous pipelining. In some implementations, the described techniques use hardware transaction barriers (e.g., mbarriers) to synchronize a dedicated copy engine (e.g., TMA) and a compute engine (e.g., tensor cores), thereby ensuring data tiles are fully loaded into SRAM before tensor cores initiate computation, and preventing race conditions between successive data streams. In some implementations, the described techniques can achieve near-peak memory bandwidth utilization while enabling privacy-preserving training throughput comparable to non-private training.

In some implementations, the described techniques use a peer-to-peer inter-core communication protocol (e.g., the distributed shared memory (DSMEM)) to aggregate partial gradients, thereby bypassing the HBM during the reduction process. In some implementations, the described techniques employ a dynamic heuristic to enable temporal splitting (e.g., split-T parallelism) only when spatial parallelism (e.g., from dimensions d and p tiling) is insufficient to saturate hardware (e.g., a GPU's streaming multiprocessors), thereby ensuring optimal hardware occupancy without incurring unnecessary reduction overhead. In some implementations, a hierarchical reduction topology is adopted in the described techniques, where multiple worker streaming multiprocessors of the GPU compute partial gradient results independently and push these results directly to a designated leader streaming multiprocessor's scratchpad memory (e.g., SRAM) for final aggregation. Therefore, the described techniques synergize DSMEM-based peer-to-peer communication, conditionally activated temporal splitting, and hierarchical on-chip reduction to not only maximize parallel computing efficiency but also maintain the constant-memory advantage of the overall framework.

In some implementations, the described techniques employ a dynamic heuristic (e.g., vis a just-in-time (JIT) tuner) to enable temporal splitting (e.g., split-T parallelism) only when spatial parallelism (e.g., from dimensions d and p tiling) is insufficient to saturate hardware (e.g., a GPU's streaming multiprocessors), thereby ensuring optimal hardware occupancy without incurring unnecessary reduction overhead. In some implementations, different or additional benefits/advantages may be achieved.

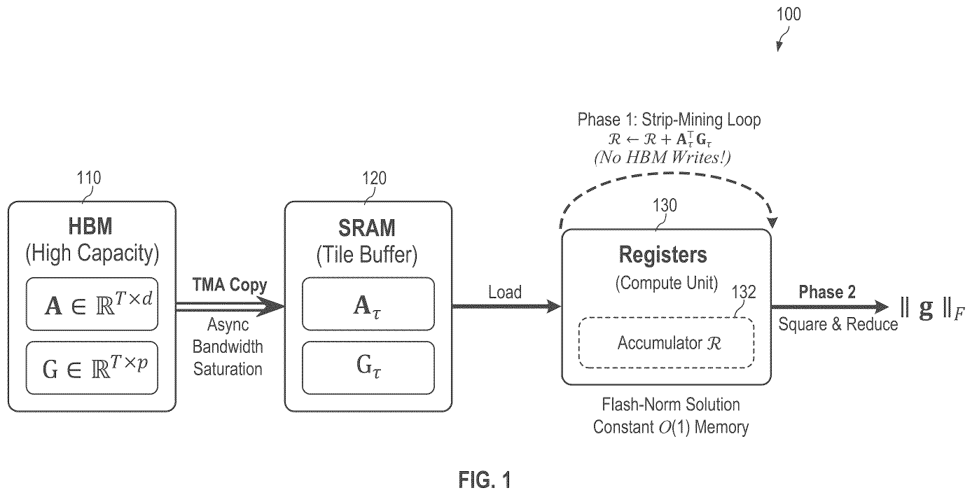

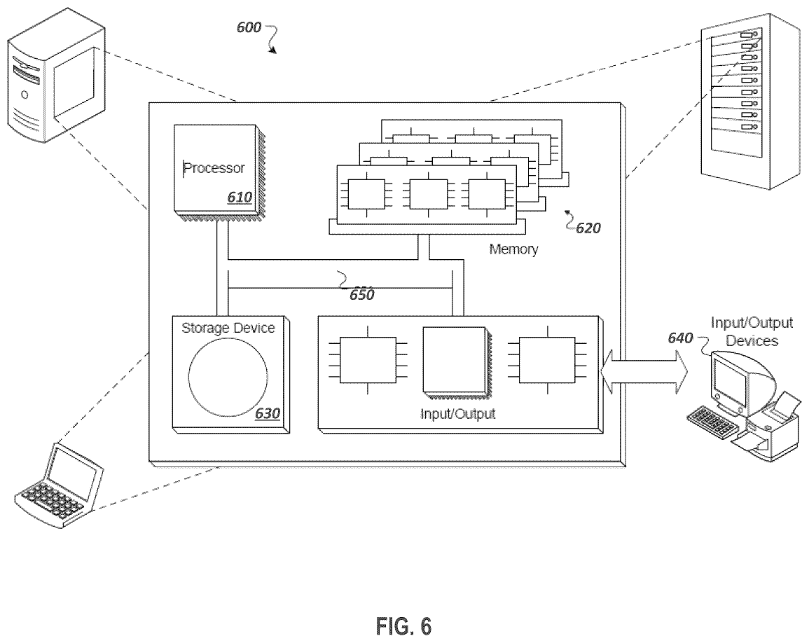

FIG. 1 illustrates a schematic diagram of an example process 100 of determining the [symbol] ₂ norms for samples in a model training database via a register-centric strip-mined decomposition approach. In some implementations, the process 100 can be performed by a system (e.g., the computing system 600 shown in FIG. 6), located in one or more locations, and programmed appropriately in accordance with this specification. In some implementations, the system can use software only, hardware only, or a combination of software, hardware, and/or firmware to implement process 100. The operations shown in process 100 may not be exhaustive, and other operations can be performed as well before, after, or in between any of the illustrated operations. Further, some of the operations may be omitted or performed simultaneously, or in a different order than shown in FIG. 1.

In some implementations, a database for training machine learning models (e.g., LLMs or DiTs) can be partitioned into a plurality of mini-batches (each serving as one input for a training iteration), where each mini-batch contains a plurality of independent samples. The number of samples included in a mini-batch can be determined by the mini-batch size. As an example, a mini-batch includes B samples when the mini-batch size is B. In some implementations, each sample (e.g., denoted as b) within the mini-batch has a corresponding input activation tensor (e.g., denoted as A_{b}) associated with the forward propagation output of the sample b and a corresponding output gradient tensor (e.g., denotes as G_{b}) derived from the backpropagation of the loss function for the sample b.

To efficiently process the input activation tensors A_{b} and output gradient tensors G_{b} of samples in the plurality of mini-batches, processors such as dedicated high-performance processors can be used to, for example, accelerate the computation and gradient accumulation steps of model training. In some implementations, the process 100 can be performed on processors such as graphics processing units (GPUs), tensor processing units (TPUs), general-purpose computing on graphics processing units (GPGPUs), or multi-core central processing units (CPUs). For conciseness, a GPU is used as an example throughout the specification. It is understood that other processors can be used for implementations of process 100, and other processes/methods described in the specification.

In some implementations, the GPU can employ a hierarchical storage architecture including high-capacity off-chip memory (e.g., HBM 110) and low-capacity on-chip memory (e.g., SRAM 120 and registers 130). For example, HBM 110 is the outermost storage layer of the GPU, offering a high capacity (e.g., 80 GB) but relatively low bandwidth (˜3.35 TB/s) and high latency. As shown in FIG. 1, in some implementations, HBM 110 can serve as a persistent storage location for large-scale data such as the input activation tensor A⁽ⁱ⁾∈ [symbol] and the output gradient tensor G⁽ⁱ⁾∈ [symbol] . SRAM 120 is the intermediate cache located on the GPU's streaming multiprocessors (SMs), with a smaller capacity but far higher bandwidth (e.g., ˜30+TB/s) than HBM 110 and low latency. Streaming multiprocessors refer to the core parallel computing units integrated within the GPU, serving as the fundamental hardware responsible for executing parallel thread blocks, arithmetic operations, and memory access tasks, etc. In some implementations, each streaming multiprocessor can also include thread-local register files (e.g., registers 130) and compute engines (e.g., tensor cores for performing matrix multiply-accumulate operations. As shown in FIG. 1, in some implementations, SRAM 120 can serve as a temporary buffer between HBM 110 and registers 130 for caching tensor tiles (for example, tiles of the input activation tensor A (e.g., denoted as A_{τ}) and tiles of the output gradient tensor G (e.g., denoted as G_{τ})) streamed from HBM 110. Registers 130 are at the innermost storage layer of the GPU, with the smallest capacity but optimal bandwidth and latency (e.g., approaching the native speed of computing units). In some implementations, registers 130 can be used to hold intermediate results during computation. As shown in FIG. 1, in some implementations, a dedicated accumulator [symbol] 132 can be allocated within the registers 130 for directly accumulating gradients in the registers 130.

As shown in FIG. 1, in some implementations, for a sample in a mini-batch, its input activation tensor A and output gradient tensor G can be partitioned into sub-tensors at HBM 110. These sub-tensors are streamed in the form of tiles (e.g., denoted as tiles A_{τ} and tiles G_{τ}) to the SRAM 120 via a tensor memory accelerator (TMA) and are then loaded to registers 130 to compute accumulated gradients directly in registers via a linear accumulation operation (e.g., referred to as Phase 1). In some implementations, after the full sequence of the sample is processed, a non-linear reduction operation is performed at the registers 130 to determine the gradient norm (e.g., denoted as ∥g⁽ⁱ⁾∥_{F}) of the sample, ensuring the intermediate matrix (e.g., the gradient for the weight matrix W given by ∇W=A^{T}G) would not leave the registers 130. Therefore, the gradient accumulation for each sample can be performed entirely within the registers 130, eliminating the need to materialize intermediate gradient matrices in HBM 110 of the GPU and thus achieving a constant memory complexity that is independent of the sequence length T of the individual sample.

A detailed illustration of the register-centric strip-mined decomposition approach used in FIG. 1 is set forth below. As an example, A∈ [symbol] and G∈ [symbol] refer to the input activation tensor and the output gradient tensor for a single sample, respectively, where T denotes the sequence length of the sample (also referred to as the sequence dimension), d denotes the feature dimension of the input activation tensor, and p denotes the feature dimension of the output gradient tensor. In some implementations, the gradient for the weight matrix W can then be given by ∇W=A^{T}G. In such cases, the element at position (j, k) (i.e., the j-th row and k-th column) of the gradient ∇W is the inner product of the j-th column vector of the input activation tensor A and the k-th column vector of the output gradient tensor G, summed over the entire sequence length T of the sample. For example, the element at position (j, k) can be written as the following equation (2):

$${( ∇ W )}_{j k} = {\sum }_{t = 1}^{T} {A}_{t , j} \cdot {G}_{t , k} \qquad ( 2 )$$

where A_{t,j} refers to the element located at the t-th row and j-th column of the input activation tensor A, and G_{t,k} refers to the element located at the t-th row and k-th column of the output gradient tensor G. In some implementations, the input activation tensor A and the output gradient tensor G are stored in the high-bandwidth memory (HBM) 110 of the GPU.

In some implementations, the entire sequence length T (also referred to as the sequence dimension) is divided into N tiles of size BK, such that T=N×B_{K}. In some implementations, the sequence length T corresponds to the total number of time steps in the sample. In such cases, each tile encapsulates a contiguous subset of time steps along the sequence dimension T and thus can be referred to as the time tile. By partitioning the entire sequence length T into tiles, the GPU enables streaming processing of the sample's temporal data (i.e., the data of the sample distributed along the sequence dimension T) without loading the entire sequence of the sample into the registers 130 at once. As an example, the size B_{K} of each tile can be 128, meaning each tile contains 128 consecutive time steps from the entire full sequence of the sample. In some implementations, the above equation (2) can be rewritten as the following equation (3):

$${( ∇ W )}_{j k} = {\sum }_{τ = 1}^{N} {\underbrace{( {\sum }_{t ∈ {Tile}_{τ}} {A}_{t , j} \cdot {G}_{t , k} )}}_{Partial Accumulation from Tile τ} \qquad ( 3 )$$

where Tile, refers to the set of time indices (also referred to as the position indices of the sequence dimension T) belonging to the T-th tile among the N tiles, where τ∈[1, N]. In some implementations, these tiles are streamed from the HBM 110 to the SRAM 120 of the GPU.

In some implementations, kernel fusion is then performed to keep the intermediate accumulation entirely within the registers 130 of the GPU. Kernel fusion refers to a parallel computing optimization technique that merges a plurality of independent computation kernel functions (e.g., tensor multiplication kernel, gradient accumulation kernel) into a single kernel function executed on the streaming multiprocessors (SMs) of the GPU. As an example, an accumulator [symbol] 132 can be allocated in the thread-local registers of the GPU. As the tiles resulted from the input activation tensor A and the output gradient tensor G are streamed from the SRAM 120 to the registers 130 of the GPU, the partial products can be obtained using dedicated computing units (e.g., dedicated matrix arithmetic accelerators such as tensor cores) and be immediately accumulated in the accumulator [symbol] 132 located in the registers 130, as shown below with reference to equation (4).

$${ℛ}_{j k} ← {ℛ}_{j k} + {\sum }_{t ∈ T i l {e}_{τ}} {A}_{t , j} \cdot {G}_{t k} ∀ τ ∈ [ 1 , N ] \qquad ( 4 )$$

It can be noted that the intermediate results generated during the above gradient accumulation process are intentionally retained within the registers 130 throughout the computation, with no need for temporary storage in either the SRAM 120 or the HBM 110, thereby eliminating the latency caused by frequent data reading and writing between the computation units and the memory layers.

Furter with reference to FIG. 1, the gradient accumulation process occurring in the registers 130 includes two phases: a linear accumulation phase (e.g., referred to as the “add” phase) and a non-linear reduction phase (e.g., referred to as the “square” phase). As aforementioned, the entire sequence length T of the sample is partitioned into N discrete tiles, and each tile (e.g., denoted as tile τ, τ∈[1, N]) is associated with a sub-activation tensor A_{τ} derived from the input activation tensor A and a sub-gradient tensor G_{τ} derived from the output gradient tensor G. In some implementations, an iterative procedure is performed to accumulate the partial gradient contributions from each tile, so as to compute the final gradient norm for the sample. In some implementations, this iterative procedure can be defined as the strip-mining loop, which sequentially processes each of the N tiles along the sequence dimension T.

In some implementations, the linear accumulation phase is performed inside the strip-mining loop over T. During the linear accumulation phase, strict linear matrix additions are performed on the partial products streamed into the registers 130. In other words, within the strip-mining loop, no squaring operations are applied to intermediate results. Since the derivative operator is linear, summing the partial gradient contributions from each tile is mathematically equivalent to computing the gradient over the entire sequence length T of the sample. Upon completion of the strip-mining loop over all N tiles, the register-resident accumulator [symbol] ⱼₖ 132 holds the exact value of the corresponding element in the full gradient matrix ∇W (e.g., the element at position (j, k) of the gradient ∇W), as shown below with reference to equation (5).

$${ℛ}_{j k} = {( ∇ W )}_{j k} \qquad ( 5 )$$

It can be noted that the above entire linear accumulation phase operates exclusively within the registers 130 of the GPU, with no intermediate data written back to SRAM 120 or HBM 110. In such cases, a fixed-size accumulator [symbol] 132 is maintained in the registers 130, independent of the sequence length T and the number of tiles N, thus preserving the O(1) memory complexity.

For example, with reference to FIG. 1, the accumulator R 132 can be initialized within the thread-local registers (e.g., a thread-private register file) 130 associated with a computing unit of the GPU (e.g., a tensor core for matrix multiply-accumulate (MMA) operations, or a general-purpose CUDA core). In some implementations, the tiles resulted from the input activation tensor A and the output gradient tensor G (e.g., tiles A_{τ} and tiles G_{τ}) streamed from the global memory (e.g., HBM 110) to SRAM 120 via TMA are loaded to the thread-local registers 130, for example, in pairs. In some implementations, within the thread-local registers 130, matrix products are computed based on the tiles A_{τ} and tiles G_{τ} as

$${A}_{τ}^{⊤} {G}_{τ}$$

and are accumulated in the accumulator [symbol] 132. For example, in response to a first tile pair (e.g., A_{τ1} and G_{τ1}) being loaded into the thread-local registers 130, a first matrix product is obtained pair (e.g., A_{τ2} and G_{τ2}) being loaded into the thread-local registers 130, a second matrix product is obtained as

$${A}_{τ 2}^{⊤} {G}_{τ 2}$$

and is added to the accumulator [symbol] as

$$ℛ ← ℛ + {A}_{τ 1}^{⊤} {G}_{τ 1} .$$

Correspondingly, in response to a second tile as

$${A}_{τ 1}^{T} {G}_{τ1}$$

and is added to the accumulator [symbol] 132 as

$$ℛ ← ℛ + {A}_{τ 2}^{⊤} {G}_{τ 2} .$$

The iterative accumulation proceeds sequentially until computations on all tile pairs A_{τ} and G_{τ} are completed. In some implementations, intermediate results such as matrix products

$${A}_{τ1}^{⊤} {G}_{τ 1} and {A}_{τ 2}^{⊤} {G}_{τ 2}$$

would not be written back to the global memory (e.g., HBM 110) or shared memory (e.g., SRAM 120) of the GPU. In other words, the intermediate results would remain only in the registers 130 of the GPU.

In some implementations, upon completion of the strip-mining loop over t, the accumulator R 132 in the register 130 holds the fully aggregated gradient information. In some implementations, the non-linear reduction phase is performed after the completion of the strip-mining loop over t to determine the norm (e.g., Frobenius norm) for the sample. For example, a global reduction can be performed based on the values read directly from the registers 130 to compute a squared Frobenius norm of the gradient matrix (e.g., denoted as

$${‖ ∇ W ‖}_{F}^{2} ) .$$

In some implementations, the global reduction operation can be collectively performed by a plurality of GPU threads. As an example, the plurality of GPU threads can read values directly from their private registers 130, square each element, and perform the global reduction to compute the squared Frobenius norm of the gradient matrix, as shown with reference to the following equation (6).

$${‖ ∇ W ‖}_{F}^{2} = {\sum }_{j = 1}^{d} {\sum }_{k = 1}^{P} {( {ℛ}_{j k} )}^{2} \qquad ( 6 )$$

From the above, different from the standard DP-SGD norm determination where squaring of gradient elements is performed incrementally during accumulation

$$( e . g . , {‖ ∇ W ‖}_{F}^{2} = \sum {( ∇ {W}_{jk} )}^{2} ,$$

the described techniques defer the squaring operation until the strip-mining loop over all time tiles τ∈[1, N]) has completed. That is, the described techniques strictly separate linear accumulation from non-linear squaring, and the accumulator [symbol] 132 retains the full gradient matrix within thread-local registers 130 throughout the linear accumulation phase. This ensures mathematical exactness (capturing all cross-terms between tiles) while maintaining zero intermediate memory footprint. In particular, by deferring the squaring operation until the completion of the full linear summation, the described techniques inherently capture all cross-terms across the different sequence chunks (e.g., 2 [symbol] ΔM⁽ⁱ⁾·ΔM^{(j)}) [symbol] , which ensures exact numerical consistency with the results generated by a standard full-matrix computation. In other words, though the computation of the strip-mining loop is determined based on the sequence length T, the size of the final gradient matrix is independent of the sequence length T due to the summation reduction over the time dimension (e.g., t).

As an illustrative example, consider a layer of a machine learning model that has an input dimension of d=4096 and an intermediate dimension of p=11008. For a single sample, the corresponding gradient matrix ∇W may occupy approximately 90 MB of memory (e.g., size (∇W)=d× p×2 Bytes=4096×11008×2 Bytes≈90 MB). In accordance with the disclosed techniques, this 90 MB gradient accumulation is retained entirely within the registers 130 of the GPU. Specifically, the sequence dimension T can be processed in a streaming fashion during the linear accumulation phase, while the spatial reduction over the d×p dimensions is performed in-place during the non-linear reduction phase, thereby eliminating the need to materialize the full 90 MB gradient matrix in either SRAM 120 or HBM 110.

In some implementations, the norm of the sample is output to the HBM 110 from the registers 130. For example, the norm of the sample can be a Frobenius norm (e.g., denoted as ∥g∥²) obtained by taking the square root of the squared Frobenius norm of the gradient matrix. In some implementations, the described techniques enable the output of only a single scalar norm (e.g., 4 Bytes) for a sample to the HBM 110, without incurring any HBM read/write traffic related to the intermediate gradient computed for the sample or introducing any additional memory overhead.

Based on the above register-centric strip-mined decomposition approach, for a sample within a mini-batch, the described techniques perform partitioning on its input activation tensor A and output gradient tensor G along the sequence dimension T to fit within the capacity of the registers of the GPU and enable decomposition of the sequence length T of the sample to bypass the capacity limits of SRAM of the GPU. The disclosed techniques can also achieve constant-memory gradient norm computation with exact numerical consistency by performing gradient accumulation exclusively within registers to eliminate global memory write traffic. For example, the weight gradient of the sample and the corresponding gradient norm are determined entirely within the registers, with only the gradient norm being written back to the HBM, thereby achieving an O(1) constant memory complexity as a result. Moreover, the described techniques decouple the linear accumulation phase from the non-linear reduction phase for norm computation to ensure computational exactness while maintaining a constant memory footprint.

In some implementations, the described techniques can further achieve zero-accuracy-loss gradient computation. As aforementioned, the full gradient matrix ∇W can be computed as an inner product over the sequence dimension T. For example, the sequence of T time steps (e.g., sequence indices {1, . . . , T}) can be partitioned into disjoint tiles τ₁, . . . , τ_{K}, and thus the gradient accumulation can be performed via the following equation (7):

$$R ← {\sum }_{k} ( {\sum }_{t ∈ {τ}_{k}} {A}_{t}^{⊤} {G}_{t} ) \qquad ( 7 )$$

Based on the associativity and commutativity of matrix addition, the partial gradients are first accumulated within each tile, then combined globally in the register-resident accumulator [symbol] . This mathematical property guarantees that the accumulator [symbol] retains the exact value of the full gradient matrix ∇W with zero approximation error, regardless of the execution order of time tiles.

In some implementations, the described techniques can also achieve theoretical data movement (I/O) efficiency, where the I/O complexity is defined as the total number of elements transferred between HBM and on-chip memory (e.g., SRAM and registers) of the GPU. In some implementations, assume that the total size of the input activation tensor A and the output gradient tensor G is Dᵢₙ=T (d+p), where T is the sequence dimension (total number of time steps of a sample), d is the feature dimension of the input activation tensor A, and p is the dimension of the output gradient tensor G. As derived from fundamental algorithm complexity and information-theoretic principles, any exact gradient norm computation algorithm has a theoretical lower bound for the I/O complexity of Ω(Dᵢₙ). This lower bound Ω(Dᵢₙ) may arise because every element of the input activation tensor A and the output gradient tensor G contributes to the gradient norm and must be loaded at least once. However, the described techniques load the input activation tensor A and the output gradient tensor G exactly once in a tiled streaming fashion (e.g., with reference to equation (3)), thereby attaining the theoretical lower bound of Ω(Dᵢₙ). Further, given that results are accumulated exclusively in the registers during the linear accumulation phase and the reduction is performed in-place during the non-linear reduction phase, no intermediate matrices (e.g., partial gradient matrices or Gram matrices) are written to the HBM, thereby reducing the write complexity to a negligible scalar output. That is, the only HBM write operation corresponds to the final scalar norm, which introduces a negligible constant overhead of O(1), that is independent of the input size Dᵢₙ. Thus, the total I/O complexity (e.g., denoted as [symbol] ) of the described techniques can asymptotically achieve the theoretical lower bound Ω(Dᵢₙ) with an I/O cost as follows:

$${ℳ}_{IO} = Θ ( {𝒟}_{in} ) + O ( 1 ) \qquad ( 8 )$$

where Θ( [symbol] ) refers to the core data transfer cost that matches the theoretical lower bound for exact gradient norm computation, and O(1) refers to the constant overhead corresponding to the write-back of the final scalar output.

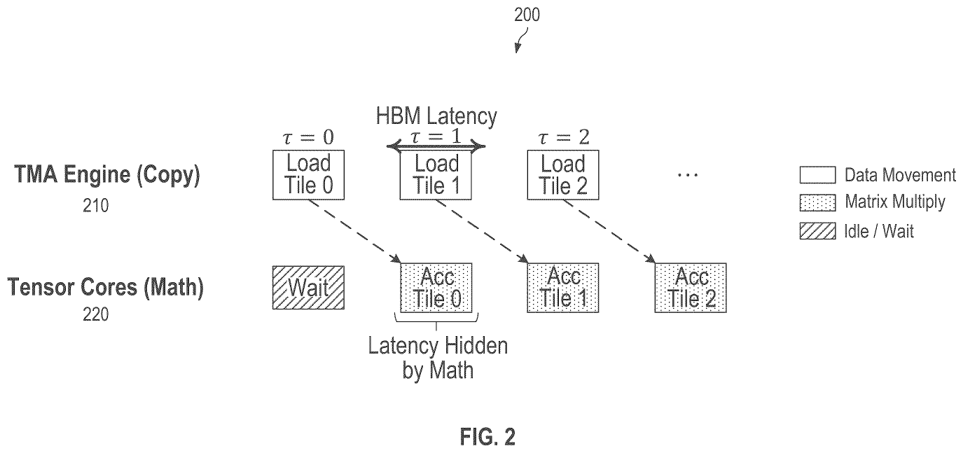

In some implementations, to bridge the gap between algorithmic O(1) memory complexity and peak hardware performance of the GPU, tensor memory accelerator (TMA) can be used to decouple data movement from tensor core computation (e.g., the MMA operations executed by the tensor cores), thereby mitigating the speed mismatch between data transfer and computation during the large-scale model training. In some implementations, as shown in FIG. 1, TMA can be configured to move multi-dimensional tiles between HBM 110 and SRAM 120. In some implementations, TMA can be configured to perform asynchronous prefetching. For example, TMA independently initiates asynchronous data fetch operations to retrieve the data from HBM 110 concurrently with the matrix arithmetic operations executed by the tensor cores. For example, when the tensor cores execute matrix arithmetic operations (e.g., warp-group matrix multiply-accumulate (WGMMA) operations) to process a current data tile (e.g., denoted as t), the TMA can asynchronously fetch a subsequent tile (e.g., denoted as τ+1) from HBM 110, as shown in FIG. 2.

FIG. 2 illustrates a schematic diagram of an example asynchronous pipelining process 200 that decouple data movement from computation. In some implementations, the asynchronous pipelining process 200 is implemented between on-chip memory and off-chip memory of a GPU. In some implementations, the asynchronous pipelining process 200 is implemented based on a TMA. In some implementations, the asynchronous pipelining process 200 can be performed by a system (e.g., the computing system 600 shown in FIG. 6), located in one or more locations, and programmed appropriately in accordance with this specification. In some implementations, the system can use software only, hardware only, or a combination of software, hardware, and/or firmware to implement the asynchronous pipelining process 200.

As shown in FIG. 2, a TMA engine (also referred to as a copy engine) 210 is used to prefetch tile τ+1 while tensor cores 220 process tile t. This overlapping of computation and data transfer can reduce the HBM access latency, as the next tile is available in on-chip memory (e.g., SRAM) immediately upon completion of the current tile's processing. In some implementations, the scheduler of the processor (e.g., CPU or GPU) issues asynchronous bulk-copy instructions to the TMA engine 210, where the instructions operate independently of the compute threads. Therefore, these instructions do not block tensor cores 220 from executing, for example, matrix multiply-accumulate (MMA) operations.

In some implementations, TMA engine 210 can also be configured to perform hardware boundary checking. For example, TMA engine 210 can handle spatial boundary checks (e.g., padding input sequences that cannot be evenly divided by the block size) directly in hardware, reducing instruction-level overhead for the streaming multiprocessors (SMs). In some implementations, TMA engine 210 can further be configured to perform descriptor-based addressing. For example, TMA engine 210 can use descriptors to define the geometry of the input activation tensors A∈ [symbol] and gradient tensors DW∈ [symbol] , where each descriptor encodes the geometric properties (e.g., dimensions, stride values, memory layout, etc.) of the target tensor. Thereby, TMA engine 210 is enabled to perform complex strided memory access without requiring the kernel loop to execute manual address calculation logic, simplifying kernel code and reducing computational overhead.

For standard dense layers, the spatial dimensions (d, p) usually provide abundant parallelism. To leverage this parallelism efficiently, a grid-stride partitioning strategy is employed, where the output weight-gradient matrix ∇W is portioned into tiles of size B_{M}×B_{N}. In such cases, the total number of spatial thread blocks (TBs) can be determined by the number of such tiles across the dimensions (d, p), with each thread block assigned to process one exclusive tile to achieve full parallelization. In some implementations, the total number of thread blocks can be determined as follows:

$${G}_{spatia1} = B \times ⌈ \frac{d}{{B}_{M}} ⌉ \times ⌈ \frac{p}{{B}_{N}} ⌉ \qquad ( 9 )$$

In some implementations, architectures such as low-rank adaptation (LoRA) where the rank p (or called the dimension p) is much smaller than the dimension d (e.g., p<<d) or DiTs which feature a moderately sized dimension d, suffer from inherent limitations in spatial dimensions. In particular, the spatial grid [symbol] ₛₚₐₜᵢₐₗ associated with such architectures is often insufficiently sized to fully saturate the GPU's computational resources (e.g., GPU occupancy is less than 15%), resulting in a condition referred to as GPU starvation, where the GPU operates well below its peak theoretical throughput. In some implementations, the described techniques further provide a split-T partitioning mechanism to partition the sequence length T along the sequence dimension into K parallel, disjoint time segment splits, thereby scaling the effective compute grid size to [symbol] _{new}= [symbol] ₛₚₐₜᵢₐₗ×K. This partitioning and subsequent gradient aggregation can be executed via a hardware-accelerated map-reduce computation pattern including two distinct phases: a map phase (also referred to as the parallel partial gradient accumulation phase) and a reduce phase (also referred to as the distributed shared memory (DSMEM) tree reduction phase).

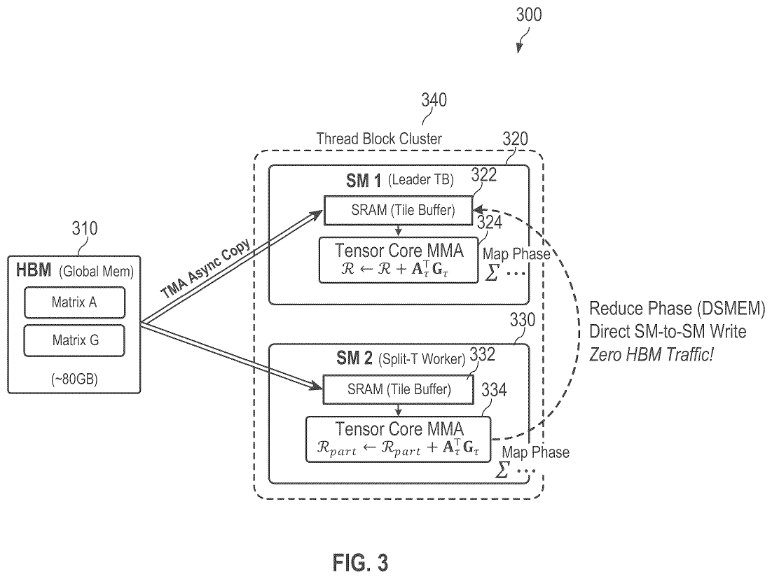

FIG. 3 illustrates an example dataflow 300 according to the split-T partitioning mechanism. As shown in FIG. 3, TMA asynchronously streams tiles resulting from the input activation tensor A and the output gradient tensor G (e.g., tiles A_{τ} and G_{τ}) from the HBM 310 to distinct SRAMs (e.g., SRAMs 322 and 332), effectively hiding HBM access latency. For example, a first plurality of tiles A_{τ} and G_{τ} are streamed from the HBM 310 to the SRAM 322 within the streaming multiprocessor 320 of the GPU, while a second plurality of tiles A_{τ} and G_{τ} are streamed from the HBM 310 to the SRAM 332 within the streaming multiprocessor 330 of the GPU

In some implementations, during the map phase, each of the K thread blocks (TBs) is assigned to a unique time segment of the partitioned sequence, and independently computes a partial gradient matrix ΔW^{(k)} for its assigned time segment. In other words, partial gradient accumulation operations are performed independently for each time segment derived from the partitioned sequence. In some implementations, these partial gradient accumulation operations are performed within thread-local registers of a GPU's streaming multiprocessors (SMs). For example, as shown in FIG. 3, register-centric gradient accumulations can be performed locally within each of the streaming multiprocessors 320 and 330 of the GPU. In particular, the partial gradient values can be computed and accumulated exclusively within the thread-local registers of the GPU's streaming multiprocessors 320 and 330. In some implementations, the register-centric gradient accumulation can be performed via a register-resident accumulator [symbol] within each of the streaming multiprocessors 320 and 330. For example, in response to TMA asynchronously streams tiles A_{τ} and G_{τ} from HBM 310 to SRAMs 322 and 332 of the streaming multiprocessors 320 and 330, tensor cores 324 and 334 of the streaming multiprocessors 320 and 330 can retrieve these tiles A_{τ} and G_{τ} and execute, for example, matrix multiply-accumulate (MMA) operations to compute partial gradients for each time segment. The resulting partial gradient values are then immediately stored in thread-local registers and iteratively accumulated into the register-resident accumulator [symbol] . In some implementations, after completing accumulation for their assigned time segments, each of the streaming multiprocessors 320 and 330 retains the full partial gradient matrix in its thread-local registers, preparing for the subsequent reduce phase. During the map phase, since no intermediate partial gradient data is spilled to off-register memory hierarchies, eliminating HBM write traffic for transient gradient results is eliminated, and memory access latency to near-zero for accumulation operations is reduced.

In some implementations, during the reduce phase, DSMEM is used to aggregate the K partial results obtained from the K thread blocks without incurring HBM overhead. In some implementations, the K thread blocks are grouped into a thread block cluster (TBC) 340, and a log-step tree reduction is implemented within this cluster 340. In some implementations, during the reduce phase, partial gradient results are aggregated directly into the SRAM 322 or 332 of one of the streaming multiprocessors 320 and 330 using DSMEM. For example, the streaming multiprocessors 320 and 330 can include a leader streaming multiprocessor (e.g., the streaming multiprocessor 320) and one or more worker streaming multiprocessors (e.g., the streaming multiprocessor 330). In some implementations, a leader thread block is deployed on the leader streaming multiprocessor 320 to manage the aggregation process, while worker thread blocks run on respective worker streaming multiprocessors 330. As shown in FIG. 3, the partial gradient results can be directly aggregated into the SRAM 322 of the leader streaming multiprocessor 320. For example, partial gradient results generated by the worker thread blocks can be transmitted via high-bandwidth SM-to-SM interconnects to the SRAM 322 of the leader streaming multiprocessor 320, and the leader thread block can then perform the log-step tree reduction on the leader streaming multiprocessor 320 to aggregate the results stored in the SRAM 322. From the above, such a tree-based aggregation approach ensures the reduction process completes in a logarithmic number of steps relative to K (e.g., with a time complexity of O(log K)), with the entire operation performed exclusively within the on-chip memory, thereby completely bypassing HBM-related bottlenecks during the reduce phase and preserving the “zero HBM write” property inherent to the overall architecture.

In some implementations, a saturation-based heuristic (also referred to as “unified scheduling heuristic”) is provided to determine a split factor K for splitting the sequence length T in the above split-T partitioning mechanism, thereby enabling the dynamic selection of the optimal configuration at runtime. In some implementations, the split factor K denotes the number of parallel splits for the sequence length T and is determined as follows:

$$K = \{ \begin{matrix}1 & if {g}_{spatia1} \geq α \cdot {N}_{SM} ( saturated , e . g . , FFN LM Head ) \\ ⌊ \frac{α \cdot {N}_{SM}}{{g}_{spatia1}} ⌋ & if {g}_{spatia1} < α \cdot {N}_{SM} ( Starved , e . g . , LoRA )\end{matrix} \qquad ( 10 )$$

where [symbol] ₛₚₐₜᵢₐₗ refers to the total number of thread blocks; N_{SM} refers to the number of streaming multiprocessors, and α refers to a saturation factor (e.g., ranging from 2 to 4). With reference to equation (10), when if [symbol] ₛₚₐₜᵢₐₗ<α·N_{SM}, the split-T partitioning mechanism is enabled, such that the sequence length T is divided into K parallel time segments, where

$$K = ⌊ \frac{α \cdot {N}_{SM}}{{g}_{spatia1}} ⌋ .$$

In some implementations, such a saturation-based heuristic ensures the split-T partitioning mechanism is only activated when necessary to prevent GPU starvation. This enables GPU occupancy to be prioritized and maximized by scaling the compute grid via splitting T into K parallel time segments, while minimizing the overhead associated with the subsequent logarithmic-step tree reduction.

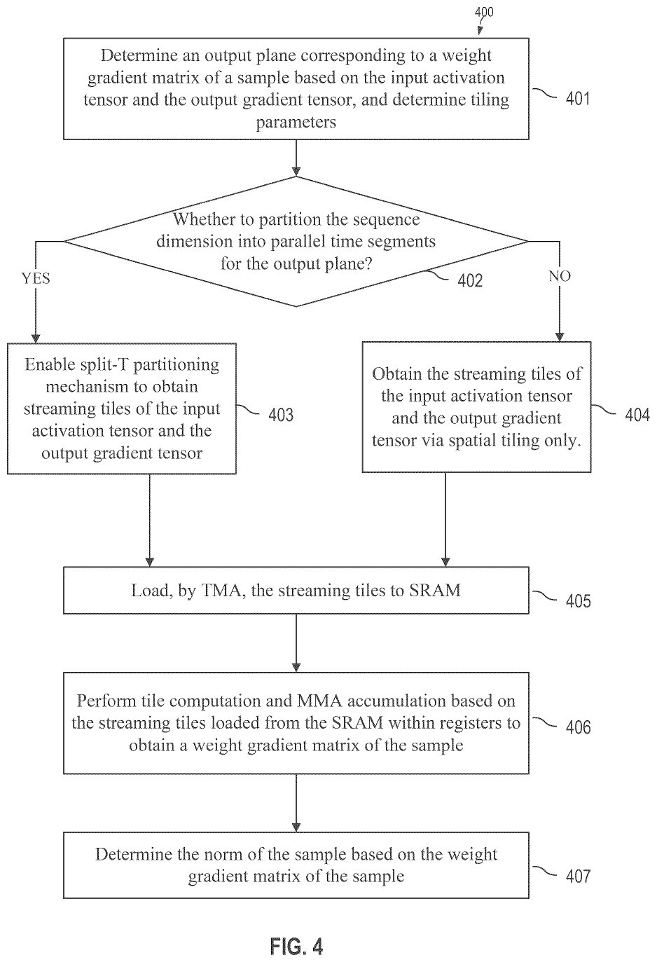

FIG. 4 illustrates an example process 400 of determining pre-sample norms for samples in a mini-batch of data for training a machine learning model. In some implementations, the process 400 can be performed by a system (e.g., the computing system 600 shown in FIG. 6), located in one or more locations, and programmed appropriately in accordance with this specification. In some implementations, the system can use software only, hardware only, or a combination of software, hardware, and/or firmware to implement process 400. The operations shown in process 400 may not be exhaustive, and other operations can be performed as well before, after, or in between any of the illustrated operations. Further, some of the operations may be omitted or performed simultaneously, or in a different order than shown in FIG. 4.

At 401, an output plane corresponding to a weight gradient matrix of the sample is determined based on the input activation tensor A and the output gradient tensor G_{τ} and tiling parameters (e.g., B_{M}, B_{N}, B_{K}) are determined. In some implementations, the output plane is determined based on the spatial dimensions of the input activation tensor A and the output gradient tensor G. For example, in some implementations, for a linear layer of the machine learning model with an input activation tensor A∈ [symbol] and an output gradient tensor G∈ [symbol] , the per-example weight gradient matrix can be ∇W=A^{T}G∈ [symbol] . Therefore, the output plane of the per-example weight gradient ∇W can be denoted as the output plane (d×p). In some implementations, the tiling parameters B_{M}, B_{N}, B_{K} are predetermined parameters, where By defines the tile size for partitioning the feature dimension d of the input activation tensor A, By defines the tile size for partitioning the feature dimension p of the output gradient tensor G_{τ} and B_{K} defines the chunk size for streaming the sequence dimension (also referred to as the temporal dimension) T. In some implementations, based on these parameters, spatial tiling is performed on the input activation tensor A along the spatial dimension d and on the output gradient tensor G along the spatial dimension p to decompose the full output gradient matrix ∇W into non-overlapping spatial tiles of fixed dimension B_{M}×B_{N}.

At 402, a determination is made as to whether to partition the sequence dimension T into K parallel time segments for the output plane (d×p). In some implementations, the determination is made based on the parallelism sufficiency of the spatial dimensions (e.g., d, p) and the overhead trade-off of temporal partitioning. For example, the determination can be made based on whether the number of non-overlapping spatial tiles of fixed dimension B_{M}×B_{N} generated from the full output gradient matrix ∇W is sufficient to fully occupy all streaming multiprocessors of the GPU, and/or whether the performance gains from increased GPU occupancy via splitting T outweigh the overhead incurred by the subsequent log-step tree reduction across K time segments. In some implementations, the determination is performed via the unified scheduling heuristic as mentioned above. For example, with reference to equation (10), an example quantitative saturation check can be performed by making a comparison between the total number of thread blocks (e.g., [symbol] ₛₚₐₜᵢₐₗ) and a product of the number of streaming multiprocessors (e.g., N_{SM}) and a hyperparameter (e.g., the saturation factor α, which ranges from 2 to 4) to determine whether to partition the sequence dimension T into K parallel time segments for the output plane (d×p).

In some implementations, if the spatial-only tiling fails to saturate the GPU compute resources (e.g., [symbol] ₛₚₐₜᵢₐₗ<α·N_{SM}), the sequence dimension T (which is shared by the input activation tensor A and the output gradient tensor G) is partitioned into K (where K≠1 and

$$K = ⌊ \frac{α \cdot {N}_{SM}}{{g}_{spatia1}} ⌋ )$$

parallel time segments for the output plane (d×p) via split-T partitioning mechanism. This partitioning expands the compute grid for the output plane (d×p) by splitting the input activation tensor A and the output gradient tensor G into K parallel temporal chunks, with each chunk further split into streaming tiles A_{τ} and G_{τ} of size B_{K}×d and size B_{K}×p, respectively. In other words, at 403, the split-T partitioning mechanism is enabled to obtain the streaming tiles A_{τ} and G_{τ}.

In some implementations, if the spatial tiling provides sufficient parallelism (e.g., [symbol] ₛₚₐₜᵢₐₗ≥α·N_{SM}), no partitioning is performed on the sequence dimension T. In other words, the split-T partitioning mechanism is disabled when spatial tiling provides sufficient parallelism. In some implementations, the streaming tiles A_{τ} and Gr can be obtained by performing spatial-only partitioning on the input activation tensor A along its feature dimension d and on the output gradient tensor G along its feature dimension p. In some implementations, each streaming tile A_{τ} has a size of B_{M} along the feature dimension d, and each streaming tile G_{τ} has a size of B_{N} along the feature dimension p. In other words, at 404, the streaming tiles A_{τ} and G_{τ} are obtained via spatial tiling only, and the split-T partitioning mechanism is disabled.

At 405, the streaming tiles A_{τ} and G_{τ} are loaded to the SRAM by a tensor memory accelerator (TMA). In some implementations, the TMA loads the streaming tiles A_{τ} and G_{τ} asynchronously from the HBM to the SRAM, as shown with reference to FIG. 2. In some implementations, the integration of TMA can be realized via a multi-stage software pipeline, with synchronization between stages achieved via hardware transaction barriers (also referred to as mbarrier). As an example, the multi-stage software pipeline can be a three-stage software pipeline including the following stages: a data loading stage (also referred to as the stage i+2), a barrier waiting stage (also referred to as the stage i+1), and a computation stage (also referred to the stage i). In some implementations, during the data loading stage, the TMA performs asynchronous prefetching of the streaming tiles (i.e., A_{τ} and G_{τ}) from the HBM to the SRAM of the GPU's streaming multiprocessors (e.g., as shown in FIG. 2). In some implementations, during the barrier waiting stage, warps within the thread blocks wait for the mbarrier signals issued by the TMA to confirm that the prefetched tiles have been completely and correctly loaded into the SRAM, ensuring data validity. In some implementations, during the computation stage, tensor cores of the GPU perform operations (e.g., warp-group matrix multiply accumulate (WGMMA) operations on the tiles stored in the SRAM. In some implementations, these operations, such as WGMMA, are performed in a register-centric manner. In other words, the intermediate results of the operations are accumulated directly in the registers. Given that the operation is memory-bound (e.g., characterized by low arithmetic intensity), the computation time is shorter than the data fetch time. The above multi-stage software pipeline can continuously supply data to the computing units, thereby fully saturating the HBM bandwidth (e.g., approximately 3 TB/s).

In some implementations, warps within a thread block are functionally specialized to execute distinct operations, where each warp focuses on a single type of operation, thereby reducing instruction cache thrashing and maximizing overall throughput of the kernel. In some implementations, the warps within a thread block can be partitioned into at least one group of producer warps and at least one group of consumer warps. In some implementations, the quantity of each group can be selected based on the hardware parallelism of the target GPU and the computational demands of the gradient accumulation workflow. As an example, the warps within a thread block can be divided into one group of producer warps and three groups of consumer warps to balance data prefetching latency and arithmetic computation throughput. In some implementations, the group of producer warps is exclusively responsible for issuing commands for the TMA engine (e.g., TMA copy commands) to asynchronously stream data (e.g., streaming tiles A_{τ} and G_{τ}) from the HBM to the SRAM and managing hardware transaction barriers (e.g., mbarriers) to synchronize the multi-stage pipeline (e.g., ensuring data validity before computation). In some implementations, the group of consumer warps is specialized in executing, for example, WGMMA instructions for gradient accumulation and/or other arithmetic operations (e.g., partial sum reduction) on the data stored in the SRAM.

At 406, tile computation and MMA accumulation are performed based on the streaming tiles (i.e., A_{τ} and Gr) loaded from the SRAM within registers to obtain a weight gradient matrix (e.g., ∇W) of the sample. In some implementations, the weight gradient matrix ∇W can be obtained based on the above equation (3).

At 407, a norm (e.g., Frobenius norm) of the sample is determined based on the weight gradient matrix ∇W of the sample. In some implementations, the norm of the sample can be determined based on the above equation (6). In some implementations, the norm of the sample, rather than the full weight gradient matrix, is written back to the HBM, thereby significantly alleviating the storage burden on HBM by eliminating the need to materialize intermediate gradient tensors.

An example algorithm related to spatial tiling is provided below with reference to Algorithm 1. In particular, Algorithm 1 provides an example process for spatial tiling with output-discarding register accumulation, where partitioning is performed across both the spatial dimensions (e.g., T) and the feature dimensions (e.g., d, p) of the input activation tensor A and the output gradient tensor G for all samples in a mini-batch size B.

Algorithm 1: Spatial Tiling (Output-
Discarding Register Accumulation)

| Require: A ∈ [symbol] , G ∈ [symbol] , block sizes B_{M}, B_{N}, B_{K}, batch size B | |
|---|---|
| 1: | DW ← 0^{p×d}, norms ← 0^{B} |
| 2: | for m = 0 to ┌d/B_{M}┐ − 1 do |
| 3: | for n = 0 to ┌d/B_{N}┐ − 1 do |
| 4: | acc_global ← 0 |
| 5: | for b = 0 to B − 1 do |
| 6: | acc_b ← 0 |
| 7: | for k = 0 to T − 1 step B_{K} do |
| 8: | Take A_{τ}, G_{τ} ∈ [symbol] , [symbol] |
| 9: | acc_b ← acc_b + A_{τ}^{T}G_{τ} |
| 10: | end for |
| 11: | acc_global ← acc_global + acc_b |
| 12: | norms[b] ← norms[b] + Σ(acc_b ⊙ acc_b) |
| 13: | end for |
| 14: | Write acc_global to DW[nB_{N}: (n + 1)B_{N}], |
| | DW[mB_{M}: (m + 1)B_{M}] |
| 15: | end for |
| 16: | end for |

The above Algorithm 1 employs a spatial tiling strategy to partition the output plane (of dimension d×p) into tiles (or referred to as “blocks”) of size (B_{M}, B_{N}), while streaming the dimension of sequence length T in contiguous chunks of size B_{K}. In some implementations, for each sample (e.g., denoted as b) within a mini-batch of the training dataset, the pre-sample contributions

$${A}_{τ}^{⊤} {G}_{τ}$$

are accumulated entirely in the registers, and the temporal intermediates are discarded after reduction. In some implementations, the norm of the sample is computed based on tiled intermediate results acc_b, and the register-based accumulation of acc_b optimizes memory access by obviating the need to retain full intermediate output tensors. In some implementations, only the aggregated tile accumulation (e.g., acc_global) for the entire mini-batch is written to the weight-gradient matrix DW of the model. The pre-sample norm (e.g., norms [b]) is updated by summing the element-wise square of the intermediate tile accumulation (e.g., Σ(acc_b⊙acc_b)) to support gradient clipping. In some implementations, the above output-discarding design achieves a memory cost independent of T (with the memory footprint bounded only by tile sizes and norm storage), avoids materializing the Ω(Bdp) tensor of per-sample gradients, and preserves exact gradients across all tiles.

In some implementations, the weight-gradient matrix DW∈ [symbol] is partitioned into tiles of size (B_{N}, B_{M}) along its dimensions (p, d), thereby limiting the working set to a single tile at a time. In some implementations, the sequence dimension T is processed in contiguous chunks of size B_{K}. For each chunk T, the kernel forms

$${A}_{τ}^{⊤} {G}_{τ}$$

and immediately reduces this intermediate product into the per-sample accumulators acc_b. In some implementations, ephemeral intermediate tensors are retained exclusively in registers of the GPU. Upon completion of each reduction step, these temporary values are discarded, while only the aggregated tile accumulator acc_global is preserved, which is then written back to the weight-gradient matrix DW via a single coalesced memory write operation. In some implementations, per-sample norms (e.g., norms [b]) are updated via Σ(acc_b⊙acc_b) during the linear accumulation phase, eliminating the need for additional data passes and redundant computations. In some implementations, the final value of the weight-gradient matrix DW corresponds to the exact summation over the full sequence dimension T. In other words, the above spatial tiling process merely reorganizes the order of computation and memory access patterns to optimize efficiency, without introducing any gradient approximation.

In some implementations, with reference to Algorithm 1, the order of the strip-mining loop iterates over spatial tiles (m, n) across the (d, p) dimensions first, followed by individual samples b, and finally streams over the sequence axis k along the sequence dimension T in strides of B_{K}. In some implementations, for each tile, the kernel maintains acc_global in the on-chip memory (e.g., registers or shared memory such as SRAM) of the GPU, and performs a single write-back operation to the corresponding tile region of DW[nB_{N}:(n+1) B_{N}], DW[mB_{M}:(m+1) B_{M}]. In some implementations, the tile sizes B_{M}, B_{N}, B_{K} are selected to align with the hardware's MMA fragment sizes and shared-memory bandwidth constraints. In some implementations, the tile sizes are fully compatible with the TMA pipeline, enabling asynchronous prefetching of data for chunk τ+1 while the reduction for chunk t is in progress.

In some implementations, by streaming over the sequence dimension T and avoiding materializing intermediate tensors in main memory (e.g., HBM of the GPU), the overall memory overhead becomes completely independent of sequence dimension T. Instead, the memory overhead is bounded by the tile buffers and the per-sample norms vector. In some implementations, the single coalesced write operation per tile can minimize the HBM traffic. In some implementations, when combined with TMA asynchronous prefetching, bandwidth-saturated hardware utilization can be achieved.

An example algorithm related to TMA that performs asynchronous prefetching of streaming tiles into SRAM is provided below with reference to Algorithm 2. In particular, Algorithm 2 provides an example process of a multi-stage software pipeline.

Algorithm 2: TMA Asynchronous Copy with Software Pipelining

Require: Tile sequence τ = 0, ... , N − 1
1: Prefetch τ = 0 into SRAM
2: for τ = 0 to N − 1, do
3: Issue TMA async copy for τ + 1
4: $Load τ into registers and perform MMA : ℛ ← ℛ + {G}_{τ}^{T} {A}_{τ}$
5: Wait for TMA as needed
6: end for

With reference to the above Algorithm 2, constant memory overhead can be achieved during gradient computation through the synergistic design of TMA and register-centric accumulation

$$( e . g . , ℛ ← ℛ + {G}_{τ}^{⊤} {A}_{τ} ) .$$

In particular, the TMA engine treats the sequence dimension T as a streaming resource. For example, tiles corresponding to the sequence dimension T can be asynchronously transferred to the GPU's streaming multiprocessors via TMA, while gradient accumulation operations can be directly performed in registers. In some implementations, the tiles corresponding to the sequence dimension T are discarded immediately after computation without being stored in on-chip memory (e.g., SRAM, registers) or the HBM. Therefore, the intermediate materialization of per-sample gradients, which requires a memory complexity of Ω(Bdp), can be avoided.

An example algorithm related to split-T partitioning mechanism is provided below with reference to Algorithm 3. In particular, Algorithm 3 parallelizes the reduction over the time axis (i.e., the time dimensions T) by splitting [0, T) into S segments. In some implementations, each of the S segments is assigned to one of the worker streaming multiprocessors. In some implementations, the worker streaming multiprocessors are configured to compute all segment-wise partial accumulations

$$( e . g . , {acc\_partial}^{( s )} = {\sum }_{τ ∈ segment s} {G}_{τ}^{T} {A}_{τ} )$$

and aggregate them into a shared buffer (e.g., SRAM) of a leader streaming multiprocessor via DSMEM. For example, each worker streaming multiprocessor can compute

$${acc\_partial}^{( s )} = {\sum }_{τ ∈ segment s} {G}_{τ}^{⊤} {A}_{τ}$$

using register/shared-memory accumulation with no intermediate writes to the HBM. These partial accumulations acc_partial^{(s)} are then written via DSMEM into the SRAM of the leader streaming multiprocessor for aggregation, thereby eliminating the need to transfer the partial accumulations to and from the HBM. In some implementations, the leader streaming multiprocessor performs the on-chip aggregation to obtain a batch-level gradient accumulation (e.g., acc_b=Σₛ acc_partial^{(s)}), updates the batch-specific gradient norm (e.g., norms [b]), and writes the spatially tiled global gradient accumulation (e.g., acc_global) to the HBM (e.g., the weight gradient buffer DW residing in the HBM).

Algorithm 3: Split-T Parallel Reduction

Requires: Split factor S, time range [0, T)
1: Partition [0, T) evenly into S segments
2: for s = 0 to S − 1 in parallel do
3: $On the worker SM , compute {acc\_partial}^{( s )} = {\sum }_{τ ∈ {segment}_{s}} {G}_{τ}^{T} {A}_{τ}$
4: Write via DSMEM into the leader SM’s shared buffer
5: end for
6: Leader aggregates acc_b = Σₛ acc_partial^{(s)}
7: Accumulate into acc_global, and update norms[b] ← norms[b] + Σ(acc_{b} ⊙ acc_{b})
8: Write this tile’s acc_global back to DW

With reference to the above Algorithm 3, the above on-chip aggregation can reduce data traffic to and from the HBM and lower inter-SM synchronization overhead for processing long sequence contexts (e.g., with large sequence length T). In some implementations, the on-chip aggregation can accelerate the gradient reduction operation across the time dimensions T by leveraging parallel computation of segment-wise partial accumulations. In some implementations, the on-chip aggregation can also maintain constant memory (which is independent of sequence length T) since the segment-wise partial gradient accumulations are temporarily stored in the SRAM (rather than the HBM) and are only written to the HBM after the leader streaming multiprocessor completes the final on-chip aggregation.

From the above, the worker streaming multiprocessors and the leader streaming multiprocessor coordinate through hardware barriers (e.g., mbarrier) to ensure that data transfers via DSMEM are fully completed prior to the initiation of the on-chip gradient aggregation process, thereby eliminating risks of data inconsistency that could arise from incomplete partial data during aggregation and guaranteeing the correctness of the batch-level gradient accumulation acc_b. In some implementations, the split factor S can be dynamically selected to match the available parallelism of the GPU hardware (e.g., the number of active SMs and/or the target SM occupancy), while minimizing inter-SM communication overhead incurred by DSMEM-based data transmission. In some implementations, the on-chip aggregation (e.g., the on-chip gradient reduction) process runs concurrently with TMA-driven data prefetching. For example, worker streaming multiprocessors can process the partial gradient accumulations acc_partial^{(s)} for their assigned segments of the current tile, while the TMA engine asynchronously loads subsequent data tiles from the HBM to the. This overlapping of computation and data prefetching eliminates idle time for worker streaming multiprocessors and the TMA engine, maximizing pipeline throughput.

In some implementations, the described techniques can serve as an acceleration engine for DP-SGD paradigms. As an example, the described techniques can be applied to a high-throughput book-keeping (1-Pass) workflow (e.g., denoted as Flash-BK). Book-keeping algorithm is a variant of DP-SGD, where the output gradient tensor G is reused throughout the gradient computation to avoid double back-propagation. In some implementations, in a first phase (e.g., referred to as the fused norm kernel phase) of the Flash-BK, tiles of the input activation tensors A and output gradient tensors G are streamed based on the register-centric strip-mined decomposition approach as described above with reference to FIG. 1. In some implementations, the pre-sample partial gradients

$$A {τ}^{⊤} G τ$$

are accumulated exclusively in thread-local registers, bypassing the capacity limits of the SRAM that constrain standard tiling approaches. In some implementations, the linear accumulation (e.g., Phase 1 of FIG. 1) and non-linear reduction (e.g., Phase 2 of FIG. 1) are fused into a single kernel, reducing the memory cost of norm computation from O(Bdp) to strictly O(1). In some implementations, in response to determining that the clipping factor C is computed via the fused norm kernel, in a second phase (e.g., referred to as the weight accumulation phase) of the Flash-BK, tiles of the input activation tensors A and output gradient tensors G are re-streamed to compute the final gradient update for model weights as follows:

$$∇ W = {\sum }_{i = 1}^{B} {( {A}^{( i )} \cdot min ( 1 , \frac{C}{‖ {g}^{( i )} ‖} ) )}^{⊤} {G}^{( i )} \qquad ( 11 )$$

From the above, by leveraging the TMA-based pipelining (e.g., Algorithm 2), Flash-BK can hide the latency incurred by re-streaming the tiles of the input activation tensors A and output gradient tensors G from the HBM to SRAM by overlapping this data re-streaming process with arithmetic operations (e.g., WGMMA) performed on the streaming multiprocessors. This overlapping of memory re-streaming and arithmetic computation enables the Flash-BK to achieve computational throughput comparable to non-private SGD training (e.g., training without achieve privacy guarantees). In some implementations, Flash-BK can be deployed when a total activation size (e.g., denoted as M_{act} (B, T), where B represents the batch size, and T represents the sequence length) is smaller than the available capacity of the HBM (e.g., denoted as M_{HBM}). When M_{act} (B, T) is smaller than M_{HBM}, the TMA-based pipelining and asynchronous data transfer optimizations ensure that the bandwidth overhead incurred by re-streaming the tiles of the input activation tensors A and output gradient tensors G is rendered negligible, enabling Flash-BK to achieve near ˜100% of the training throughput observed in non-private SGD training, thereby delivering maximum practical training speed while maintaining differential privacy guarantees.

As another example, the described techniques can be applied to a memory-efficient ghost clipping (2-Pass) workflow (e.g., denoted as Flash-Ghost). Ghost clipping algorithm is preferred for scenarios where storing the input activation tensors A is computationally prohibitive (e.g., extremely long sequence contexts with large sequence length T). In some implementations, Flash-Ghost uses gradient checkpointing to recompute the input activation tensors A during the backward propagation pass, avoiding persistent storage of full input activation tensors A in the HBM. In some implementations, Flash-Ghost can be performed based on the register-centric strip-mined decomposition approach as described above with reference to FIG. 1. For example, tile-based processing of the sequence length T and register-level accumulation of gradient values are performed, thereby reducing the memory complexity from O(T²) (the memory complexity of ghost clipping) to a constant memory overhead O(1). In some implementations, Flash-Ghost enables training on arbitrarily long sequence lengths (or referred to as “infinite” sequence lengths), with the only constraint being the storage capacity required for the activation checkpoint of a single model layer. In some implementations, Flash-Ghost can be deployed when a total activation size M_{act} (B, T) is greater than or equal to the available capacity of the HBM (e.g., denoted as M_{HBM}), for example, the sequence length T is greater than or equal to 32,000. When M_{act} (B, T) is greater than or equal to M_{HBM}, by integrating gradient checkpointing with the memory complexity of O(1), additional computational overhead (attributable to the re-forward pass required to recompute tiles of the input activation tensors A) for the critical capability is traded to train on extremely long sequence lengths that would otherwise be infeasible due to HBM memory constraints.

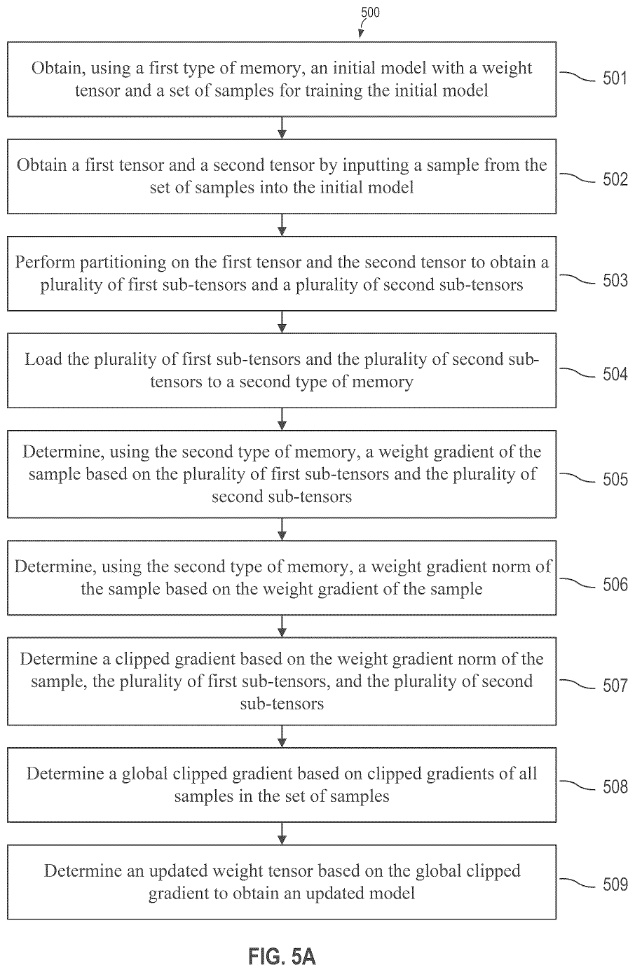

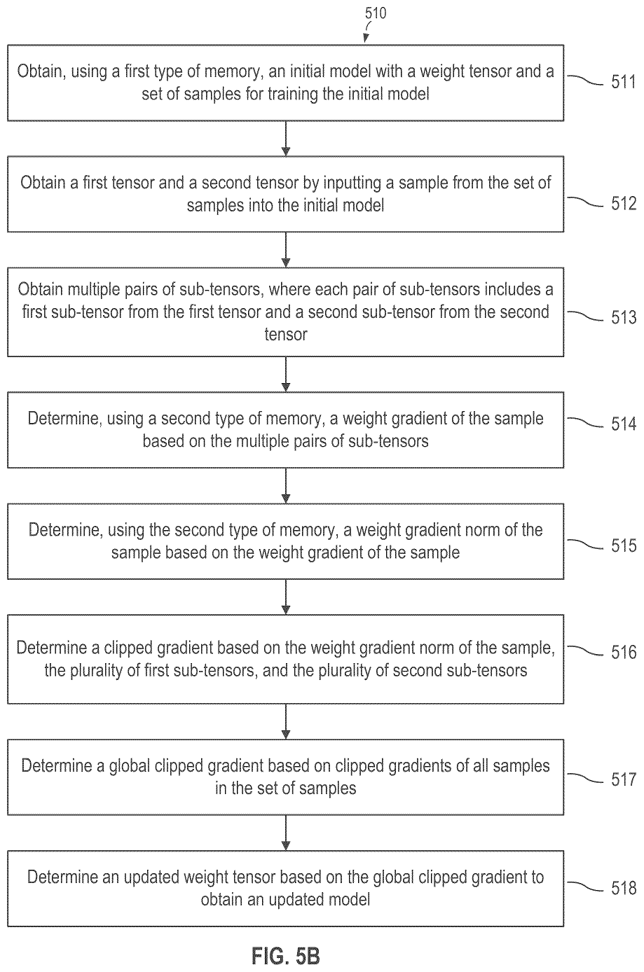

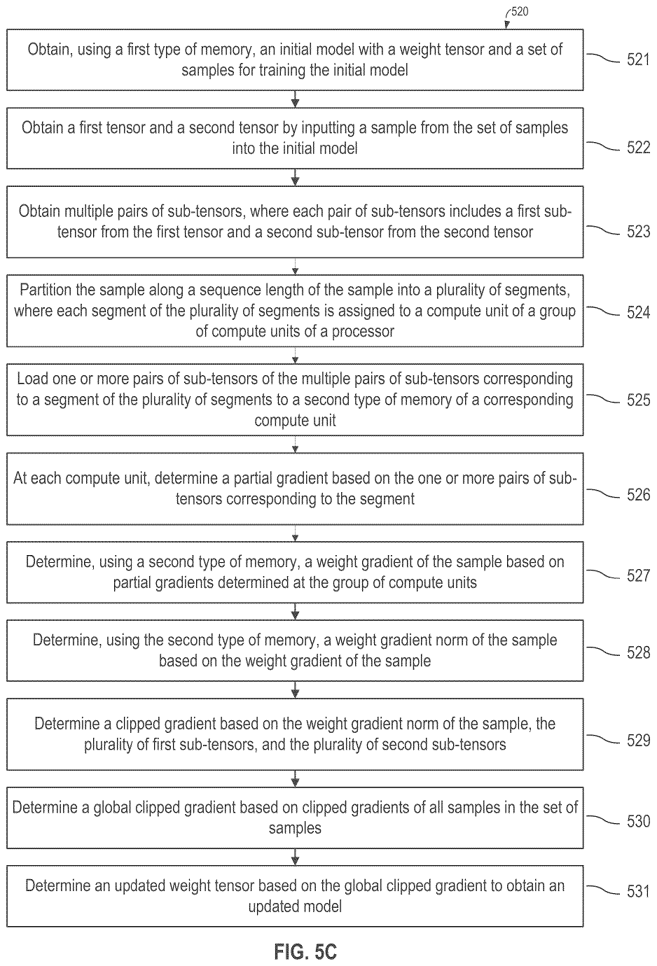

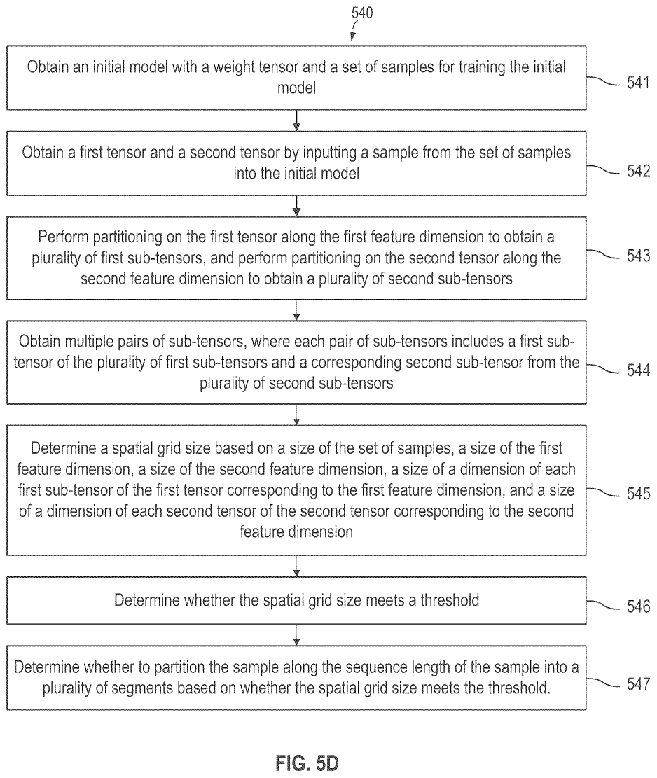

FIGS. 5A-5D below provides example processes of training a machine learning model based on differential privacy according to the techniques described herein.

FIG. 5A illustrates an example process 500 of training a machine learning model based on differential privacy. In some implementations, the process 500 can be performed by a system (e.g., the computing system 600 shown in FIG. 6), located in one or more locations, and programmed appropriately in accordance with this specification. In some implementations, the system can use software only, hardware only, or a combination of software, hardware, and/or firmware to implement process 500. The operations shown in process 500 may not be exhaustive, and other operations can be performed as well before, after, or in between any of the illustrated operations. Further, some of the operations may be omitted or performed simultaneously, or in a different order than shown in FIG. 5A.

At 501, an initial model with a weight tensor (e.g., W) and a set of samples for training the initial model are obtained using a first type of memory. In some implementations, each of the set of samples has a sequence length with a maximum of T, where T is a positive integer. In some implementations, the first type of memory can be a high-bandwidth memory (HBM) (e.g., HBM 110 of FIG. 1 or HBM 310 of FIG. 3).

At 502, a first tensor (e.g., the input activation tensor A of FIG. 1) and a second tensor (e.g., the output gradient tensor G of FIG. 1) are obtained by inputting a sample from the set of samples into the initial model. In some implementations, the first tensor is obtained by inputting the sample into the initial model and performing forward propagation. In some implementations, a loss is determined based on an output of the initial model and a label corresponding to the sample, and the second tensor is obtained by performing back propagation on the loss. In some implementations, the first tensor includes a dimension of the sequence length (e.g., dimension T) and a first feature dimension (e.g., dimension d). In some implementations, the second tensor includes the dimension of the sequence length (dimension T) and a second feature dimension (e.g., dimension p).

At 503, a plurality of first sub-tensors (e.g., A_{τ} of FIG. 1) and a plurality of second sub-tensors (e.g., Gr of FIG. 1) are obtained by performing partitioning on the first tensor and the second tensor. For example, the plurality of first sub-tensors is obtained by performing partitioning on the first tensor, and the plurality of second sub-tensors is obtained by performing partitioning on the second tensor. In some implementations, partitioning is performed on the first tensor along a first dimension of the first tensor corresponding to the sequence length. In some implementations, partitioning is performed on the second tensor along a first dimension of the second tensor corresponding to the sequence length. In some implementations, the plurality of first sub-tensors and the plurality of second sub-tensors have the same size in a dimension corresponding to the sequence length.

In some implementations, the plurality of first sub-tensors and the plurality of second sub-tensors can be obtained by splitting the sequence length into N tiles, where each of the N tiles has a length TO, and performing partitioning on the first tensor and the second tensor based on at least the length TO. In some implementations, N is a positive integer. In some implementations, a size of each of the plurality of first sub-tensors in the dimension corresponding to the sequence length is equal to the length T0, and a size of each of the plurality of second sub-tensors in the dimension corresponding to the sequence length is equal to the length T0. In some implementations, the length T0 is determined based on the first feature dimension, the second feature dimension, and a maximum storage capacity of the second type of memory.

In some implementations, the first tensor can be further partitioned along the second dimension of the first tensor corresponding to the first feature dimension to obtain the plurality of first sub-tensors. In some implementations, the second tensor can be further partitioned along the second dimension of the second tensor corresponding to the second feature dimension to obtain the plurality of second sub-tensors.

At 504, the plurality of first sub-tensors and the plurality of second sub-tensors are loaded to a second type of memory. In some implementations, the first type of memory has a larger storage capacity than the second type of memory. In some implementations, the second type of memory is an on-chip memory (e.g., SRAM 120 of FIG. 1 or SRAMs 322, 332 of FIG. 3).

At 505, a weight gradient of the sample is determined using the second type of memory based on the plurality of first sub-tensors and the plurality of second sub-tensors. In some implementations, the weight gradient of the sample is determined by computing a product of one of the plurality of first sub-tensors and one of the plurality of second sub-tensors, and updating a gradient accumulator based on the product. For example, the weight gradient of the sample can be determined based on the above equation (3)

$$( i . e . , {( ∇ W )}_{jk} = {\sum }_{τ = 1}^{N} {\underbrace{( {\sum }_{t ∈ {Tile}_{τ}} {A}_{t , j} \cdot {G}_{t , k} )}}_{Partial Accumulation from Tile τ} ) .$$

In some implementations, the product is discarded without being written to the first type of memory. For example, the weight gradient of the sample can be obtained by determining pairs of sub-tensors, where each pair of sub-tensors includes a first sub-tensor from the plurality of first sub-tensors and a second sub-tensor from the plurality of second sub-tensors. For each pair of sub-tensors, a component gradient is determined by performing a tensor multiplication based on the first sub-tensor and the second sub-tensor. Component gradients corresponding to the pairs of sub-tensors are then accumulated to obtain the weight gradient of the sample.

At 506, a weight gradient norm (e.g., Frobenius norm) of the sample is determined using the second type of memory based on the weight gradient of the sample. In some implementations, the weight gradient norm of the sample is determined by performing a non-linear reduction on the weight gradient of the sample to obtain the weight gradient norm of the sample and updating a norm accumulator based on the weight gradient norm of the sample. For example, a square of the weight gradient norm of the sample can be determined based on the above equation (6)

$$( i . e . , {‖ {g}^{( i )} ‖}_{F}^{2} = {‖ ∇ W ‖}_{F}^{2} = {\sum }_{j = 1}^{d} {\sum }_{k = 1}^{P} {( {ℛ}_{j k} )}^{2} ,$$

where ∥g⁽ⁱ⁾∥_{F} denotes the Frobenius norm of the per-sample weight gradient). In some implementations, the weight gradient norm of the sample is a scalar.

At 507, a clipped gradient is determined based on the weight gradient norm of the sample, the plurality of first sub-tensors, and the plurality of second sub-tensors. For example, the clipped gradient (e.g., denoted as

$${g}_{c l i p}^{( i )} )$$

can be determined as

$${g}_{c l i p}^{( i )} = {g}^{( i )} \cdot min ( 1 , \frac{C}{{‖ {g}^{( i )} ‖}_{2}} ) ,$$

where C indicates the gradient clipping threshold.

At 508, a global clipped gradient is determined based on clipped gradients of all samples in the set of samples. For example, the global clipped gradient (e.g., denoted as g_{global}) can be determined as

$${g}_{global} = \frac{1}{B} {\sum }_{i = 1}^{B} ( {g}^{( i )} \cdot min ( 1 , \frac{C}{{‖ {g}^{( i )} ‖}_{2}} ) ) ,$$

where B indicates the mini-batch size. In some implementations, noise (e.g., Gaussian noise) is added to the global clipped gradient. For example, the global clipped gradient with noise can be determined based on equation (1)

$$( i . e . , {g}_{global} = \frac{1}{B} {\sum }_{i = 1}^{B} ( {g}^{( i )} \cdot min ( 1 , \frac{C}{{‖ {g}^{( i )} ‖}_{2}} ) ) + 𝒩 ( 0 , {σ}^{2} {C}^{2} ) ,$$

where [symbol] (0, σ²C [symbol] ) indicates the Gaussian noise tensor).

At 509, an updated weight tensor is determined based on the global clipped gradient to obtain an updated model. For example, the updated weight tensor can be determined based on the above equation (11)

$$( i . e . , ∇ W = {\sum }_{i = 1}^{B} {( {A}^{( i )} \cdot min ( 1 , \frac{C}{‖ {g}^{( i )} ‖} ) )}^{⊤} {G}^{( i )} ) .$$

In some implementations, the updated weight tensor is determined by loading the weight tensor of the initial model to the second type of memory, updating the weight tensor of the initial model using the global clipped gradient to obtain the updated weight tensor, and writing the updated weight tensor to the first type of memory to obtain the updated model. In some implementations, the updated weight tensor is determined based on the global clipped gradient with the noise.

FIG. 5B illustrates an example process 510 of training a machine learning model based on differential privacy. In some implementations, the process 510 can be performed by a system (e.g., the computing system 600 shown in FIG. 6), located in one or more locations, and programmed appropriately in accordance with this specification. In some implementations, the system can use software only, hardware only, or a combination of software, hardware, and/or firmware to implement process 510. The operations shown in process 510 may not be exhaustive, and other operations can be performed as well before, after, or in between any of the illustrated operations. Further, some of the operations may be omitted or performed simultaneously, or in a different order than shown in FIG. 5B.

At 511, an initial model with a weight tensor (e.g., W) and a set of samples for training the initial model are obtained using a first type of memory. In some implementations, each of the set of samples has a sequence length with a maximum of T, where T is a positive integer. In some implementations, the first type of memory can be a high-bandwidth memory (HBM) (e.g., HBM 110 of FIG. 1 or HBM 310 of FIG. 3).

At 512, a first tensor (e.g., the input activation tensor A of FIG. 1) and a second tensor (e.g., the output gradient tensor G of FIG. 1) are obtained by inputting a sample from the set of samples into the initial model. In some implementations, the first tensor is obtained by inputting the sample into the initial model and performing forward propagation. In some implementations, a loss is determined based on an output of the initial model and a label corresponding to the sample, and the second tensor is obtained by performing back propagation on the loss. In some implementations, the first tensor includes a dimension of the sequence length (e.g., dimension T) and a first feature dimension (e.g., dimension d). In some implementations, the second tensor includes the dimension of the sequence length (dimension T) and a second feature dimension (e.g., dimension p).

At 513, multiple pairs of sub-tensors are obtained, where each pair of sub-tensors includes a first sub-tensor (e.g., denoted as A_{τ}) from the first tensor and a second sub-tensor (e.g., denoted as G_{τ}) from the second tensor. In some implementations, the multiple pairs of sub-tensors can be obtained by performing partitioning on the first tensor to obtain a plurality of first sub-tensors A_{τ} and performing partitioning on the second tensor to obtain a plurality of second sub-tensors G_{τ}. In some implementations, each of the plurality of first sub-tensors is paired with a corresponding one of the plurality of second sub-tensors to obtain the multiple pairs of sub-tensors.

At 514, a weight gradient of the sample is determined using a second type of memory based on the multiple pairs of sub-tensors. In some implementations, the first type of memory has a larger storage capacity than the second type of memory. In some implementations, the second type of memory is an on-chip memory including a shared memory (e.g., SRAM 120 of FIG. 1 or SRAMs 322, 332 of FIG. 3) and registers (e.g., registers 130 of FIG. 1).

In some implementations, to determine the weight gradient of the sample, a first pair of the multiple pairs of sub-tensors is loaded to a first memory of the second type of memory. In response to the first pair being loaded to the first memory, the first pair is loaded to a second memory of the second type of memory to obtain a first component gradient by performing a computation on the first pair, and a second pair of the multiple pairs of sub-tensors is loaded to the first memory without waiting for completion of the computation on the first pair. In some implementations, the first memory of the second type of memory is the shared memory, for example, the SRAM. In some implementations, the second memory of the second type of memory is the registers. In some implementations, the second pair is loaded to the first memory based on a group of first compute warps (e.g., producer warps), and the first pair is loaded to the second memory based on a group of second compute warps (e.g., consumer warps). In some implementations, in response to the second pair being loaded to the first memory, the second pair to is loaded to the second memory to obtain a second component gradient by performing the computation on the second pair, and a third pair of the multiple pairs of sub-tensors is loaded to the first memory without waiting for completion of the computation on the second pair. In some implementations, the third pair is loaded to the second memory to obtain a third component gradient by performing the computation on the third pair. And so on. In some implementations, the first pair and the second pair are asynchronously loaded to the first memory by a tensor memory accelerator (TMA) engine (e.g., TMA engine 210 of FIG. 2).

In some implementations, the computation performed on a pair of sub-tensors (e.g., the first pair or the second pair) from the multiple pairs of sub-tensors includes a multiply-accumulation operation (e.g., MMA operation). For example, the first pair can be read from the second memory to a tensor core (e.g., tensor cores 220 of FIG. 2), and the multiply-accumulation operation can then be performed on the first pair to obtain the first component gradient. Similarly, the second pair can be read from the second memory to the tensor core, and the multiply-accumulation operation can then be performed on the second pair to obtain a second component gradient.

In some implementations, the weight gradient of the sample is determined by computing a product of sub-tensors included in one pair of the multiple pairs of sub-tensors and updating a gradient accumulator based on the product. In some implementations, the product is discarded without being written to the first type of memory. In some implementations, the weight gradient of the sample can be determined based on the above equation (3)

$$( i . e . , {( ∇ W )}_{j k} = {\sum }_{τ = 1}^{N} {\underbrace{( {\sum }_{t ∈ {Tile}_{τ}} {A}_{t , j} \cdot {G}_{t , k} ) ) .}}_{Partial Accumulation from Tile τ}$$

For example, the weight gradient of the sample can be determined by accumulating the first component gradient, the second component gradient, and the third component gradient.

At 515, a weight gradient norm (e.g., Frobenius norm) of the sample is determined using the second type of memory based on the weight gradient of the sample. In some implementations, the weight gradient norm of the sample is determined by performing a non-linear reduction on the weight gradient of the sample to obtain the weight gradient norm of the sample and updating a norm accumulator based on the weight gradient norm of the sample. For example, a square of the weight gradient norm of the sample can be determined based on the above equation (6)

$$( i . e . , {‖ {g}^{( i )} ‖}_{F}^{2} = {‖ ∇ W ‖}_{F}^{2} = {\sum }_{j = 1}^{d} {\sum }_{k = 1}^{P} {( {ℛ}_{j k} )}^{2} ,$$

where ∥g⁽ⁱ⁾∥_{F} denotes the Frobenius norm of the per-sample weight gradient). In some implementations, the weight gradient norm of the sample is a scalar.

At 516, a clipped gradient is determined based on the weight gradient norm of the sample, the plurality of first sub-tensors, and the plurality of second sub-tensors. For example, the clipped gradient (e.g., denoted as

$${g}_{c l i p}^{( i )} )$$

can be determined as

$${g}_{clip}^{( i )} = {g}^{( i )} \cdot min ( 1 , \frac{C}{{‖ {g}^{( i )} ‖}_{2}} ) ,$$

where C indicates the gradient clipping threshold.

At 517, a global clipped gradient is determined based on clipped gradients of all samples in the set of samples. For example, the global clipped gradient (e.g., denoted as g_{global}) can be determined as

$${g}_{global} = \frac{1}{B} {\sum }_{i = 1}^{B} ( {g}^{( i )} \cdot min ( 1 , \frac{C}{{‖ {g}^{( i )} ‖}_{2}} ) ) ,$$

where B indicates the mini-batch size. In some implementations, noise (e.g., Gaussian noise) is added to the global clipped gradient. For example, the global clipped gradient with noise can be determined based on equation (1)

$$( i . e . , {g}_{global} = \frac{1}{B} {\sum }_{i = 1}^{B} ( {g}^{( i )} \cdot min ( 1 , \frac{C}{{‖ {g}^{( i )} ‖}_{2}} ) ) + 𝒩 ( 0 , {σ}^{2} {C}^{2} I ) ,$$

where [symbol] (0, σ²C² [symbol] ) indicates the Gaussian noise tensor).

At 508, an updated weight tensor is determined based on the global clipped gradient to obtain an updated model. For example, the updated weight tensor can be determined based on the above equation (11)

$$( i . e . , ∇ W = {\sum }_{i = 1}^{B} {( {A}^{( i )} \cdot min ( 1 , \frac{C}{‖ {g}^{( i )} ‖} ) )}^{T} {G}^{( i )} ) .$$

In some implementations, the updated weight tensor is determined by loading the weight tensor of the initial model to the second type of memory, updating the weight tensor of the initial model using the global clipped gradient to obtain the updated weight tensor, and writing the updated weight tensor to the first type of memory to obtain the updated model. In some implementations, the updated weight tensor is determined based on the global clipped gradient with the noise.

FIG. 5C illustrates an example process 520 of training a machine learning model based on differential privacy. In some implementations, the process 520 can be performed by a system (e.g., the computing system 600 shown in FIG. 6), located in one or more locations, and programmed appropriately in accordance with this specification. In some implementations, the system can use software only, hardware only, or a combination of software, hardware, and/or firmware to implement process 520. The operations shown in process 520 may not be exhaustive, and other operations can be performed as well before, after, or in between any of the illustrated operations. Further, some of the operations may be omitted or performed simultaneously, or in a different order than shown in FIG. 5C.

At 521, an initial model with a weight tensor (e.g., W) and a set of samples for training the initial model are obtained using a first type of memory. In some implementations, each of the set of samples has a sequence length with a maximum of T, where T is a positive integer. In some implementations, the first type of memory can be a high-bandwidth memory (HBM) (e.g., HBM 110 of FIG. 1 or HBM 310 of FIG. 3).

At 522, a first tensor (e.g., the input activation tensor A of FIG. 1) and a second tensor (e.g., the output gradient tensor G of FIG. 1) are obtained by inputting a sample from the set of samples into the initial model. In some implementations, the first tensor is obtained by inputting the sample into the initial model and performing forward propagation. In some implementations, a loss is determined based on an output of the initial model and a label corresponding to the sample, and the second tensor is obtained by performing back propagation on the loss. In some implementations, the first tensor includes a dimension of the sequence length (e.g., dimension T) and a first feature dimension (e.g., dimension d). In some implementations, the second tensor includes the dimension of the sequence length (dimension T) and a second feature dimension (e.g., dimension p).

At 523, multiple pairs of sub-tensors are obtained, where each pair of sub-tensors includes a first sub-tensor (e.g., denoted as A_{τ}) from the first tensor and a second sub-tensor (e.g., denoted as G_{τ}) from the second tensor. In some implementations, the multiple pairs of sub-tensors can be obtained by performing partitioning on the first tensor to obtain a plurality of first sub-tensors A_{τ} and performing partitioning on the second tensor.to obtain a plurality of second sub-tensors G_{τ}. In some implementations, each of the plurality of first sub-tensors is paired with a corresponding one of the plurality of second sub-tensors to obtain the multiple pairs of sub-tensors.

At 524, the sample is partitioned along a sequence length of the sample into a plurality of segments, where each segment of the plurality of segments is assigned to a computing unit of a group of computing units (e.g., streaming multiprocessors) of a processor. For example, a spatial grid size (e.g., [symbol] ₛₚₐₜᵢₐₗ) as is determined based on a size of the set of samples (e.g., mini-batch size B), a size of the first feature dimension (e.g., dimension d), a size of the second feature dimension (e.g., dimension p), a size of a dimension of the first sub-tensor corresponding to the first feature dimension (e.g., B_{M}), and a size of a dimension of the second sub-tensor corresponding to the second feature dimension (e.g., B_{N}). In some implementations, the spatial grid size can be determined based on the above equation (9)

$$( i . e . , {𝒢}_{spatial} = B \times ⌈ \frac{d}{{B}_{M}} ⌉ \times ⌈ \frac{p}{{B}_{N}} ⌉ ) .$$

In some implementations, a determination is further made on whether the spatial grid size is smaller than a threshold determined based on the number of computing units in the group of computing units. As an example, the threshold can be a product of the number of streaming multiprocessors (e.g., N_{SM}) and a saturation factor (e.g., α). In some implementations, in response to determining that the spatial grid size is smaller than the threshold (e.g., [symbol] ₛₚₐₜᵢₐₗ<α·N_{SM}), the sample is partitioned along the sequence length of the sample into a plurality of segments. In some implementations, each segment of the plurality of segments has an identical size. In some implementations, the number of segments included in the plurality of segments is determined based on the spatial grid size.

At 525, one or more pairs of sub-tensors of the multiple pairs of sub-tensors corresponding to a segment of the plurality of segments are loaded to a second type of memory of a corresponding computing unit. In some implementations, the first type of memory has a larger storage capacity than the second type of memory. In some implementations, the second type of memory is an on-chip memory (e.g., SRAM 120 of FIG. 1 or SRAMs 322, 332 of FIG. 3).

At 526, at each computing unit, a partial gradient is determined based on the one or more pairs of sub-tensors corresponding to the segment. For example, for each of the one or more pairs of sub-tensors, a partial gradient is determined by performing a tensor multiplication based on a pair of sub-tensors, and partial gradients corresponding to the one or more pairs of sub-tensors are accumulated to obtain the partial gradient. In some implementations, the partial gradients are determined at the group of computing units in parallel.

At 527, a weight gradient of the sample is determined based on partial gradients determined at the group of computing units. For example, the partial gradients determined at the group of computing units are aggregated to obtain the weight gradient of the sample. In some implementations, the partial gradients determined at the group of computing units are transferred to the computing unit directly without passing through the first type of memory.

At 528, a weight gradient norm (e.g., Frobenius norm) of the sample is determined using the second type of memory based on the weight gradient of the sample. In some implementations, the weight gradient norm of the sample is determined by performing a non-linear reduction on the weight gradient of the sample to obtain the weight gradient norm of the sample and updating a norm accumulator based on the weight gradient norm of the sample. For example, a square of the weight gradient norm of the sample can be determined based on the above equation (6)

$${( i . e . , {‖ {g}^{( i )} ‖}_{F}^{2} = {‖ ∇ W ‖}_{F}^{2} = {\sum }_{j = 1}^{d} {\sum }_{k = 1}^{P} {ℛ}_{j k} )}^{2} ,$$

where ∥g⁽ⁱ⁾∥_{F} denotes the Frobenius norm of the per-sample weight gradient). In some implementations, the weight gradient norm of the sample is a scalar.

At 529, a clipped gradient is determined based on the weight gradient norm of the sample, the plurality of first sub-tensors, and the plurality of second sub-tensors. For example, the clipped gradient (e.g., denoted as

$${g}_{c l i p}^{( i )} )$$

can be determined as

$${g}_{clip}^{( i )} = {g}^{( i )} \cdot min ( 1 , \frac{C}{{‖ {g}^{( i )} ‖}_{2}} ) ,$$

where C indicates the gradient clipping threshold.

At 530, a global clipped gradient is determined based on clipped gradients of all samples in the set of samples. For example, the global clipped gradient (e.g., denoted as g_{global}) can be determined as

$${g}_{global} = \frac{1}{B} {\sum }_{i = 1}^{B} ( {g}^{( i )} \cdot min ( 1 , \frac{C}{{‖ {g}^{( i )} ‖}_{2}} ) ) ,$$

where B indicates the mini-batch size. In some implementations, noise (e.g., Gaussian noise) is added to the global clipped gradient. For example, the global clipped gradient with noise can be determined based on equation (1)

$$( i . e . , {g}_{global} = \frac{1}{B} {\sum }_{i = 1}^{B} ( {g}^{( i )} \cdot min ( 1 , \frac{C}{{‖ {g}^{( i )} ‖}_{2}} ) ) + 𝒩 ( 0 , {σ}^{2} {C}^{2} I ) ,$$

where [symbol] (0, σ²C² [symbol] ) indicates the Gaussian noise tensor).

At 531, an updated weight tensor is determined based on the global clipped gradient to obtain an updated model. For example, the updated weight tensor can be determined based on the above equation (11)

$$( i . e . , ∇ W = {\sum }_{i = 1}^{B} {( {A}^{( i )} \cdot min ( 1 , \frac{C}{‖ {g}^{( i )} ‖} ) )}^{T} {G}^{( i )} ) .$$

In some implementations, the updated weight tensor is determined by loading the weight tensor of the initial model to the second type of memory, updating the weight tensor of the initial model using the global clipped gradient to obtain the updated weight tensor, and writing the updated weight tensor to the first type of memory to obtain the updated model. In some implementations, the updated weight tensor is determined based on the global clipped gradient with the noise.

FIG. 5D illustrates an example process 540 of training a machine learning model based on differential privacy. In some implementations, the process 540 can be performed by a system (e.g., the computing system 600 shown in FIG. 6), located in one or more locations, and programmed appropriately in accordance with this specification. In some implementations, the system can use software only, hardware only, or a combination of software, hardware, and/or firmware to implement process 540. The operations shown in process 540 may not be exhaustive, and other operations can be performed as well before, after, or in between any of the illustrated operations. Further, some of the operations may be omitted or performed simultaneously, or in a different order than shown in FIG. 5D.

At 541, an initial model with a weight tensor (e.g., W) and a set of samples for training the initial model are obtained. In some implementations, each of the set of samples has a sequence length with a maximum of T, where T is a positive integer. In some implementations, a first type of memory is used to obtain the initial model and the set of training samples. In some implementations, the first type of memory can be a high-bandwidth memory (HBM) (e.g., HBM 110 of FIG. 1 or HBM 310 of FIG. 3).

At 542, a first tensor (e.g., the input activation tensor A of FIG. 1) and a second tensor (e.g., the output gradient tensor G of FIG. 1) are obtained by inputting a sample from the set of samples into the initial model. In some implementations, the first tensor is obtained by inputting the sample into the initial model and performing forward propagation. In some implementations, a loss is determined based on an output of the initial model and a label corresponding to the sample, and the second tensor is obtained by performing back propagation on the loss. In some implementations, the first tensor includes a dimension of the sequence length (e.g., dimension T) and a first feature dimension (e.g., dimension d). In some implementations, the second tensor includes the dimension of the sequence length (dimension T) and a second feature dimension (e.g., dimension p).

At 543, a plurality of first sub-tensors (e.g., denoted as A_{τ}) is obtained by performing partitioning on the first tensor along the first feature dimension, and a plurality of second sub-tensors (e.g., denoted as G_{τ}) is obtained by performing partitioning on the second tensor along the second feature dimension. In some implementations, the plurality of first sub-tensors and the plurality of second sub-tensors have a same size in a dimension corresponding to the sequence length.

At 544, multiple pairs of sub-tensors are obtained based on the plurality of first sub-tensors and the plurality of second sub-tensors. In some implementations, each pair of sub-tensors includes a first sub-tensor of the plurality of first sub-tensors and a corresponding second sub-tensor from the plurality of second sub-tensors.

At 545, a spatial grid size (e.g., [symbol] ₛₚₐₜᵢₐₗ) is determined based on a size of the set of samples (e.g., mini-batch size B), a size of the first feature dimension (e.g., dimension d), a size of the second feature dimension (e.g., dimension p), a size of a dimension of the first sub-tensor corresponding to the first feature dimension (e.g., B_{M}), and a size of a dimension of the second sub-tensor corresponding to the second feature dimension (e.g., B_{N}). For example, the spatial grid size can be determined based on the above equation (9)

$$( i . e . , {G}_{spatial} = B \times ⌈ \frac{d}{{B}_{M}} ⌉ \times ⌈ \frac{p}{{B}_{N}} ⌉ ) .$$

At 546, a determination is made on whether the spatial grid size meets a threshold. In some implementations, the threshold is determined based on a number of computing units in the plurality of computing units. As an example, the threshold can be a product of the number of streaming multiprocessors (e.g., N_{SM}) and a saturation factor (e.g., a) (i.e., α·N_{SM}). In some implementations, in response to determining that the spatial grid size is smaller than the threshold (e.g., [symbol] ₛₚₐₜᵢₐₗ<α·N_{SM}), the sample is partitioned along the sequence length of the sample into a plurality of segments. In some implementations, each segment of the plurality of segments has an identical size. In some implementations, the number of segments included in the plurality of segments is determined based on the spatial grid size.

At 547, a determination is made on whether to partition the sample along the sequence length of the sample into a plurality of segments based on the determination of whether the spatial grid size meets the threshold.

In some implementations, in response to determining that the spatial grid size does not meet the threshold (e.g., [symbol] ₛₚₐₜᵢₐₗ<α·N_{SM}), a first computation strategy is performed on the plurality of first sub-tensors and the plurality of second sub-tensors to obtain a weight gradient of the sample. In some implementations, the first computation strategy includes loading the multiple pairs of sub-tensors to more than one second type of memory of the plurality of computing units of the processor and determining, using the more than one second type of memory, the weight gradient of the sample based on the multiple pairs of sub-tensors. In some implementations, the second type of memory is an on-chip memory (e.g., SRAM 120 of FIG. 1 or SRAMs 322, 332 of FIG. 3). In some implementations, the first type of memory has a larger storage capacity than the second type of memory.

In some implementations, by performing the first computation strategy, the sample is partitioned along a sequence length of the sample into a plurality of segments, where each segment of the plurality of segments is assigned to one of the plurality of computing units (e.g., streaming multiprocessors) of a processor. In some implementations, one or more pairs of sub-tensors of the multiple pairs of sub-tensors corresponding to a segment of the plurality of segments are loaded to a second type of memory of a corresponding computing unit. In some implementations, at each computing unit, a partial gradient is determined based on the one or more pairs of sub-tensors. For example, for each of the one or more pairs of sub-tensors, a partial gradient is determined by performing a tensor multiplication based on a pair of sub-tensors, and partial gradients corresponding to the one or more pairs of sub-tensors are accumulated to obtain the partial gradient. In some implementations, the partial gradients are determined at the computing units in parallel. In some implementations, a weight gradient of the sample is determined based on partial gradients determined at all computing units. For example, the partial gradients determined at all computing units are aggregated to obtain the weight gradient of the sample. In some implementations, the partial gradients determined at all computing units are transferred to a single computing unit directly without passing through the first type of memory.

In some implementations, in response to determining that the spatial grid size meets the threshold (e.g., [symbol] ₛₚₐₜᵢₐₗ≥α·N_{SM}), a second computation strategy is performed on the plurality of first sub-tensors and the plurality of second sub-tensors to obtain a weight gradient of the sample. In some implementations, the second computation strategy includes loading the multiple pairs of sub-tensors to a second type of memory of a computing unit of the plurality of computing units of the processor, and determining, using the second type of memory, the weight gradient of the sample based on the multiple pairs of sub-tensors.

In some implementations, the weight gradient of the sample is determined by computing a product of one of the plurality of first sub-tensors and one of the plurality of second sub-tensors, and updating a gradient accumulator based on the product. For example, the weight gradient of the sample can be determined based on the above equation (3)

$$( i . e . , {( ∇ W )}_{j k} = {\sum }_{τ = 1}^{N} {\underbrace{( {\sum }_{t ∈ T i l {e}_{τ}} {A}_{t , j} \cdot {G}_{t , k} )}}_{Partial Accumulation from Tile τ} ) .$$

In some implementations, the product is discarded without being written to the first type of memory. For example, the weight gradient of the sample can be obtained by determining pairs of sub-tensors, where each pair of sub-tensors includes a first sub-tensor from the plurality of first sub-tensors and a second sub-tensor from the plurality of second sub-tensors. For each pair of sub-tensors, a component gradient is determined by performing a tensor multiplication based on the first sub-tensor and the second sub-tensor. Component gradients corresponding to the pairs of sub-tensors are then accumulated to obtain the weight gradient of the sample.

In some implementations, a weight gradient norm (e.g., Frobenius norm) of the sample is determined using the second type of memory based on the weight gradient of the sample. In some implementations, the weight gradient norm of the sample is determined by performing a non-linear reduction on the weight gradient of the sample to obtain the weight gradient norm of the sample and updating a norm accumulator based on the weight gradient norm of the sample. For example, a square of the weight gradient norm of the sample can be determined based on the above equation (6)

$$( i . e . , {‖ {g}^{( i )} ‖}_{F}^{2} = {‖ ∇ W ‖}_{F}^{2} = {\sum }_{j = 1}^{d} {\sum }_{k = 1}^{P} {( {ℛ}_{j k} )}^{2} ,$$

where ∥g⁽ⁱ⁾∥_{F} denotes the Frobenius norm of the per-sample weight gradient. In some implementations, the weight gradient norm of the sample is a scalar.

In some implementations, a clipped gradient is determined based on the weight gradient norm of the sample, the plurality of first sub-tensors, and the plurality of second sub-tensors. For example, the clipped gradient (e.g., denoted as

$${g}_{c l i p}^{( i )} )$$

can be determined as

$${g}_{c l i p}^{( i )} = {g}^{( i )} \cdot min ( 1 , \frac{C}{{‖ {g}^{( i )} ‖}_{2}} ) ,$$

where C indicates the gradient clipping threshold.

In some implementations, a global clipped gradient is determined based on the clipped gradients of all samples in the set of samples. For example, the global clipped gradient (e.g., denoted as g_{global}) can be determined as

$${g}_{global} = \frac{1}{B} {\sum }_{i = 1}^{B} ( {g}^{( i )} \cdot min ( 1 , \frac{C}{{‖ {g}^{( i )} ‖}_{2}} ) ) ,$$

where B indicates the mini-batch size. In some implementations, noise (e.g., Gaussian noise) is added to the global clipped gradient. For example, the global clipped gradient with noise can be determined based on equation (1)

$$( i . e . , {g}_{global} = \frac{1}{B} {\sum }_{i = 1}^{B} ( {g}^{( i )} \cdot min ( 1 , \frac{C}{{‖ {g}^{( i )} ‖}_{2}} ) ) + 𝒩 ( 0 , {σ}^{2} {C}^{2} ) ,$$

where [symbol] (0, σ²C² [symbol] ) indicates the Gaussian noise tensor).

In some implementations, an updated weight tensor is determined based on the global clipped gradient to obtain an updated model. For example, the updated weight tensor can be determined based on the above equation (11)

$$( i . e . , ∇ W = {\sum }_{i = 1}^{B} {( {A}^{( i )} \cdot min ( 1 , \frac{C}{‖ {g}^{( i )} ‖} ) )}^{⊤} {G}^{( i )} ) .$$

In some implementations, the updated weight tensor is determined by loading the weight tensor of the initial model to the second type of memory, updating the weight tensor of the initial model using the global clipped gradient to obtain the updated weight tensor, and writing the updated weight tensor to the first type of memory to obtain the updated model. In some implementations, the updated weight tensor is determined based on the global clipped gradient with the noise.

Therefore, the techniques disclosed herein provide a high-performance, constant-memory gradient primitive that effectively resolves the longstanding tradeoff between rigorous privacy guarantees (e.g., differential privacy) and training efficiency in long-sequence machine learning model training. As an example, in comparison with conventional methods (e.g., Opacus (having a memory complexity of O(Bdp)), ghost clipping (having a memory complexity of O(T²)), standard backward kernels (B_{K}) (having a memory complexity of O(Bdp)), the techniques disclosed herein (also referred to as “flash-norm”) can achieve a memory complexity of O(1), ensuring constant memory overhead. Below is a comparison between the conventional methods and the techniques disclosed herein, with reference to Table 1. In particular, Table 1 illustrates the peak memory usage (units: MB) incurred for gradient norm computation for each method, where the batch size B=1. In some implementations, to evaluate the performance of the gradient norm primitive in isolation, experiments are conducted on a feed-forward network (FFN) layer of a model that features an input dimension d of 4096 and an intermediate dimension p of 11008 (e.g., Llama-2-7B model), and the experiments use the BF16 (Bfloat16) numerical precision for computations.

TABLE 1
Peak memory usage (units: MB) for gradient
norm computation (batch size B = 1)

| Method | 4K | 16K | 32K | 64K | 128K |
|---|---|---|---|---|---|
| Opacus/Standard BK (O(Bdp)) | 90 | 90 | 90 | 90 | 90 |
| Ghost clipping (O(T²)) | 52 | 840 | OOM | OOM | OOM |
| Flash-norm (O(1)) | 16 | 16 | 16 | 16 | 16 |

From Table 1, ghost clipping exhibits memory explosion under long-context scenarios, resulting in out-of-memory (OOM) errors when the sequence length T is 32,000 or greater. Both Opacus and standard BK require full materialization of gradients. Although their memory usage is manageable at a batch size of B=1, their memory footprint scales linearly with the batch size (will be further described below), which inherently limits the training throughput. In contrast, Flash-Norm breaks the memory wall (which refers to a core bottleneck in high-performance computing where the speed of computing units (e.g., GPU's streaming multiprocessors) far outpaces memory system latency/bandwidth, constraining overall performance) and maintains a constant, near-zero memory footprint (e.g., 16 MB) irrespective of the sequence length T or the batch size B, thereby validating the effectiveness of the register-centric design of the techniques disclosed herein.

In some implementations, the effective memory bandwidth of the techniques disclosed herein is measured, and the results show that the techniques disclosed herein (Flash-Norm) achieve 2.9 TB/s, which equals 86% of the theoretical peak bandwidth. This proves that the TMA-based asynchronous pipeline (see, e.g., Algorithm 2) included in the techniques disclosed herein can effectively mask computation latency. Even in the 1-pass workflow (involving two rounds of data reading), the kernel remains bandwidth-bound, achieving a 1.8× speedup over ghost clipping that operates in a compute-bound state.

In some implementations, the techniques disclosed herein are evaluated under two complementary training regimes for differential privacy: the high-throughput regime (1-Pass) that focuses on maximizing training throughput via batch size scaling, and the infinite context regime (2-Pass/Flash-Ghost workflow) that targets pushing sequence length limits using gradient checkpointing.

In some implementations, based on the high-throughput regime, it can be determined that the techniques disclosed herein enable larger batch sizes. Below is an analysis of the critical impact of memory efficiency on the training throughput of Opacus, standard BK, and the techniques disclosed herein, with reference to Table 2. In particular, Table 2 illustrates the end-to-end training throughput metrics for the Llama-2-7B model with a fixed sequence length T=4k.

TABLE 2
Peak memory usage (units: MB) for gradient
norm computation (batch size B = 1)

| Method | MAX BATCH | SPEED (TK/S) | vx. Non-DP |
|---|---|---|---|
| Non-private | 32 | 3,450 | 1.00x |
| Opacus | 4 | 980 | 0.28x |
| Standard BK | 4 | 1,550 | 0.45x |
| Flash-norm | 32 | 3,310 | 0.96x |

From the above Table 2, Opacus is severely limited by its memory complexity (which scales as O(Bdp) with respect to batch size B, input dimension d, and intermediate dimension p), thereby forcing the use of an extremely small maximum batch size (Bₘₐₓ=4) and resulting in suboptimal hardware utilization. Though the standard B_{K} reduces computation time by eliminating redundant re-forward operations, it still requires the full materialization of gradient tensors for gradient norm calculation. Therefore, standard B_{K} encounters the identical memory wall bottleneck as Opacus, with a maximum supported batch size of Bₘₐₓ=4 that limits its theoretical computational speedup. In contrast, the techniques disclosed herein can eliminate the above memory wall bottleneck, enabling scaling of the maximum batch size to Bₘₐₓ=32 and full saturation of the HBM bandwidth of the target hardware. In particular, Flash-Norm removes the memory bound, allowing B_{K}'s algorithmic advantage to be fully realized on hardware. This optimization yields a 3.3× speedup over Opacus and a 2.1× speedup over the standard B_{K}, with training throughput levels nearly matching those of non-private training workflows.

In some implementations, under the infinite context regime, the performance of different methods (e.g., FlashDP, ghost clipping, and Flash-Norm) varies significantly when the sequence length T is pushed to its limit by leveraging gradient checkpointing. For example, FlashDP (a SRAM-based method) fails at a sequence length T of 24,000 because the tile buffer size exceeds the 228 KB SRAM limit per streaming multiprocessor; and ghost clipping fails at a sequence length T of 32,000 due to HBM OOM caused by the excessive memory footprint of the Gram matrix. In contrast, given that Flash-Norm's gradient primitive features the memory complexity of O(1) (i.e., independent of the sequence length T), Flash-Norm achieves successful training even at a sequence length T of 128,000. The only limit is the memory required to store activation checkpoints, demonstrating true linear scalability.

In some implementations, to determine the impact of the above split-T partitioning mechanism (see, e.g., Algorithm 3) on low-occupancy network layers, fine-tuning experiments are conducted on a LoRA adapter configured with a rank r=16 (a scenario where spatial parallelism is inherently constrained due to the small dimension of the spatial grid defined by (d×r)). Under conventional spatial tiling schemes, this constraint results in a low SM occupancy rate of merely 12%, leaving the majority of GPU compute resources idle and underutilized. However, by activating the split-T partitioning mechanism with a segment count K=4, a substantial improvement in SM occupancy is observed, with the rate rising to a high-efficiency level of 82%. It should be noted that this significant gain of parallelism is achieved without incurring any HBM write overhead, which is a benefit enabled by the cluster-aware reduction scheme implemented via DSMEM. This optimization translates to a dramatic reduction in kernel execution time (e.g., the baseline latency of 2.43 ms is cut to 0.94 ms, corresponding to a 2.6× speedup relative to the standard tiling approach).

In some implementations, to address potential concerns regarding numerical stability associated with register-resident gradient accumulation, a comparative analysis is performed between the gradient norms computed by Flash-Norm and those derived from a high-precision FP64 reference implementation. Experimental results demonstrate that Flash-Norm (operating in BF16 precision) achieves a maximum relative error of less than 10-6, a level of numerical precision identical to that of Opacus. In contrast, FlashDP's layer-wise approximation strategy introduces gradient variance deviations of up to 15% in deep network layers, potentially affecting convergence stability.

FIG. 6 is an example computer system 600 for training machine learning models. The system 600 can be used for the operations described in association with the implementations described herein. For example, the system 600 may be included in computing devices of the one or more online components and/or the one or more offline components. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 includes one or more computer-readable media. The memory 620 can be a volatile memory unit or a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

In some implementations, engines/apparatus/accelerators can include a software-based system or subsystem that can perform one or more specific functions. Generally, an engine/accelerator will be implemented as one or more software modules or components, installed on one or more computers in one or more locations. In some cases, one or more computers will be dedicated to a particular engine; in other cases, multiple engines can be installed and run on the same computer or computers. In some implementations, an engine/accelerator can also be implemented as one or more firmware or hardware modules or components, or a combination of one or more software, firmware or hardware modules or components.

In some implementations, engines/apparatus/accelerators can include data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for training a machine learning model based on differential privacy, comprising:
obtaining, using a first type of memory, an initial model with a weight tensor and a set of samples for training the initial model;
obtaining a first tensor and a second tensor by inputting a sample from the set of samples into the initial model;
obtaining multiple pairs of sub-tensors, wherein each pair of sub-tensors comprises a first sub-tensor from the first tensor and a second sub-tensor from the second tensor;
partitioning the sample along a sequence length of the sample into a plurality of segments, wherein each segment of the plurality of segments is assigned to a computing unit of a group of computing units of a processor;
loading one or more pairs of sub-tensors of the multiple pairs of sub-tensors corresponding to a segment of the plurality of segments to a second type of memory of a corresponding computing unit, wherein the first type of memory has a larger storage capacity than the second type of memory;
at each computing unit, determining a partial gradient based on the one or more pairs of sub-tensors corresponding to the segment;
determining, using the second type of memory, a weight gradient of the sample based on partial gradients determined at the group of computing units;
determining, using the second type of memory, a weight gradient norm of the sample based on the weight gradient of the sample;
determining a clipped gradient based on the weight gradient norm of the sample and the multiple pairs of sub-tensors;
determining a global clipped gradient based on clipped gradients of all samples in the set of samples; and
determining an updated weight tensor based on the global clipped gradient to obtain an updated model.

2. The computer-implemented method of claim 1, wherein the partial gradients are determined at the group of computing units in parallel.

3. The computer-implemented method of claim 1, wherein each segment of the plurality of segments has an identical size.

4. The computer-implemented method of claim 1, wherein obtaining multiple pairs of sub-tensors based on the first tensor and the second tensor comprises:
performing partitioning on the first tensor to obtain a plurality of first sub-tensors;
performing partitioning on the second tensor to obtain a plurality of second sub-tensors; and
pairing each of the plurality of first sub-tensors with a corresponding one of the plurality of second sub-tensors to obtain the multiple pairs of sub-tensors.

5. The computer-implemented method of claim 4, wherein the first tensor includes a dimension of the sequence length and a first feature dimension and the second tensor includes the dimension of the sequence length and a second feature dimension; and wherein partitioning the sample along the sequence length of the sample into the plurality of segments comprises:
determining a spatial grid size based on a size of the set of samples, a size of the first feature dimension, a size of the second feature dimension, a size of a dimension of the first sub-tensor corresponding to the first feature dimension, and a size of a dimension of the second sub-tensor corresponding to the second feature dimension;
determining whether the spatial grid size is smaller than a threshold determined based on a number of computing units of the group of computing units; and
in response to determining that the spatial grid size is smaller than the threshold, partitioning the sample along the sequence length of the sample into the plurality of segments.

6. The computer-implemented method of claim 5, wherein a number of segments comprised in the plurality of segments is determined based on the spatial grid size.

7. The computer-implemented method of claim 1, wherein determining the partial gradient based on the one or more pairs of sub-tensors corresponding to the segment comprises:
for each of the one or more pairs of sub-tensors, determining a partial gradient by performing a tensor multiplication based on a pair of sub-tensors; and
accumulating partial gradients corresponding to the one or more pairs of sub-tensors to obtain the partial gradient.

8. The computer-implemented method of claim 1, wherein determining the weight gradient of the sample based on partial gradients determined at the group of computing units comprises:
aggregating the partial gradients determined at the group of computing units at a computing unit of the group of computing units to obtain the weight gradient of the sample, wherein the partial gradients determined at the group of computing units are transferred to the computing unit directly without passing through the first type of memory.

9. The computer-implemented method of claim 1, wherein obtaining the first tensor and the second tensor comprises:
obtaining the first tensor by inputting the sample into the initial model and performing forward propagation;
determining a loss based on an output of the initial model and a label corresponding to the sample; and
obtaining the second tensor by performing back propagation on the loss.

10. The computer-implemented method of claim 1, wherein determining, using the second type of memory, the weight gradient norm of the sample based on the weight gradient of the sample comprises:
performing a non-linear reduction on the weight gradient of the sample to obtain the weight gradient norm of the sample, wherein the weight gradient norm of the sample is a scalar; and
updating a norm accumulator based on the weight gradient norm of the sample.

11. The computer-implemented method of claim 1, wherein determining the updated weight tensor based on the global clipped gradient comprises:
loading the weight tensor of the initial model to the second type of memory;
updating the weight tensor of the initial model using the global clipped gradient to obtain the updated weight tensor; and
writing the updated weight tensor to the first type of memory to obtain the updated model.

12. The computer-implemented method of claim 1, further comprises:
adding noise to the global clipped gradient, and wherein the updated weight tensor is determined based on the global clipped gradient with the noise.

13. The computer-implemented method of claim 1, wherein the first type of memory is a high bandwidth memory (HBM), and the second type of memory is an on-chip memory.

14. One or more non-transitory computer-readable storage media storing one or more instructions that, when executable by one or more computers, cause the one or more computers to perform operations comprising:
obtaining, using a first type of memory, an initial model with a weight tensor and a set of samples for training the initial model;
obtaining a first tensor and a second tensor by inputting a sample from the set of samples into the initial model;
obtaining multiple pairs of sub-tensors, wherein each pair of sub-tensors comprises a first sub-tensor from the first tensor and a second sub-tensor from the second tensor;
partitioning the sample along a sequence length of the sample into a plurality of segments, wherein each segment of the plurality of segments is assigned to a computing unit of a group of computing units of a processor;
loading one or more pairs of sub-tensors of the multiple pairs of sub-tensors corresponding to a segment of the plurality of segments to a second type of memory of a corresponding computing unit, wherein the first type of memory has a larger storage capacity than the second type of memory;
at each computing unit, determining a partial gradient based on the one or more pairs of sub-tensors corresponding to the segment;
determining, using the second type of memory, a weight gradient of the sample based on partial gradients determined at the group of computing units;
determining, using the second type of memory, a weight gradient norm of the sample based on the weight gradient of the sample;
determining a clipped gradient based on the weight gradient norm of the sample and the multiple pairs of sub-tensors;
determining a global clipped gradient based on clipped gradients of all samples in the set of samples; and
determining an updated weight tensor based on the global clipped gradient to obtain an updated model.

15. The one or more non-transitory computer-readable storage media of claim 14, wherein the partial gradients are determined at the group of computing units in parallel.

16. The one or more non-transitory computer-readable storage media of claim 14, wherein each segment of the plurality of segments has an identical size.

17. The one or more non-transitory computer-readable storage media of claim 14, wherein obtaining multiple pairs of sub-tensors based on the first tensor and the second tensor comprises:
performing partitioning on the first tensor to obtain a plurality of first sub-tensors;
performing partitioning on the second tensor to obtain a plurality of second sub-tensors; and
pairing each of the plurality of first sub-tensors with a corresponding one of the plurality of second sub-tensors to obtain the multiple pairs of sub-tensors.

18. The one or more non-transitory computer-readable storage media of claim 17, wherein the first tensor includes a dimension of the sequence length and a first feature dimension and the second tensor includes the dimension of the sequence length and a second feature dimension; and wherein partitioning the sample along the sequence length of the sample into the plurality of segments comprises:
determining a spatial grid size based on a size of the set of samples, a size of the first feature dimension, a size of the second feature dimension, a size of a dimension of the first sub-tensor corresponding to the first feature dimension, and a size of a dimension of the second sub-tensor corresponding to the second feature dimension;
determining whether the spatial grid size is smaller than a threshold determined based on a number of computing units of the group of computing units; and
in response to determining that the spatial grid size is smaller than the threshold, partitioning the sample along the sequence length of the sample into the plurality of segments.

19. The one or more non-transitory computer-readable storage media of claim 18, wherein a number of segments comprised in the plurality of segments is determined based on the spatial grid size.

20. A computer-implemented system, comprising one or more computers and one or more computer memory devices interoperably coupled with the one or more computers and having computer-readable storage media storing one or more instructions that, when executed by the one or more computers, perform one or more operations comprising:
obtaining, using a first type of memory, an initial model with a weight tensor and a set of samples for training the initial model;
obtaining a first tensor and a second tensor by inputting a sample from the set of samples into the initial model;
obtaining multiple pairs of sub-tensors, wherein each pair of sub-tensors comprises a first sub-tensor from the first tensor and a second sub-tensor from the second tensor;
partitioning the sample along a sequence length of the sample into a plurality of segments, wherein each segment of the plurality of segments is assigned to a computing unit of a group of computing units of a processor;
loading one or more pairs of sub-tensors of the multiple pairs of sub-tensors corresponding to a segment of the plurality of segments to a second type of memory of a corresponding computing unit, wherein the first type of memory has a larger storage capacity than the second type of memory;
at each computing unit, determining a partial gradient based on the one or more pairs of sub-tensors corresponding to the segment;
determining, using the second type of memory, a weight gradient of the sample based on partial gradients determined at the group of computing units;
determining, using the second type of memory, a weight gradient norm of the sample based on the weight gradient of the sample;
determining a clipped gradient based on the weight gradient norm of the sample and the multiple pairs of sub-tensors;
determining a global clipped gradient based on clipped gradients of all samples in the set of samples; and
determining an updated weight tensor based on the global clipped gradient to obtain an updated model.
